(19) United States
(12) Patent Application Publication
(10) Pub. No.: US 2002/0075516 A1
(43) Pub. Date: Jun. 20, 2002

(54) Method and apparatus for layered printing

(76) Inventor: Dwight Marcus, Ojai, CA (US)

Correspondence Address: J.D. Harriman ll, COUDERT BROTHERS, 23rd Floor, 333 South Hope Street, Los Angeles, CA, 90071, US

(21) Appl. No.: 09/953,569

(22) Filed: Sep. 13, 2001

Related U.S. Application Data
(60) Provisional application No. 60/232,128, filed on Sep. 13, 2000.

(51) Int. Cl. G06F 15/00; B41B 1/00

(52) U.S. Cl. 358/1.18; 358/1.12

(57) ABSTRACT

Embodiments of the present invention are directed to a method and apparatus for layered printing. In one embodiment, printing is performed on a leaf of layered paper. In one embodiment, the leaf of layered paper is approximately the same thickness as a conventional sheet of paper commonly used in the printing application (e.g., business card thickness, typewriter page thickness, etc.). The layered paper is similar in appearance to conventional paper and has the ability to bond with ink or toner. In one embodiment, layered paper is formed by the layering of two or more thin layers of paper-like or plastic-like sheets. The characteristics of a sheet of layered paper include flexibility and low elasticity. In one embodiment, three thin sheets of Mylar-like plastic are coated on a side, termed the “back side”, with a non-hardening adhesive. Each thin sheet is bonded to the next by the adhesive coated side.

### RELATED APPLICATION

This application claims the benefit of U.S. Provisional Patent Application No. 60/232,128 filed Sep. 13, 2000, the disclosure of which is hereby incorporated by reference.

### BACKGROUND OF THE INVENTION

1. Field of the Invention

The present invention relates to the field of printing technology, and in particular to a method and apparatus for layered printing.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

2. Background Art

In some printing applications, the use of conventional paper is inadequate or inefficient. For example, printing a large advertisement on conventional paper requires special printers capable of printing on large sheets of paper. For another example, printing game cards (e.g., scratch-off lottery or contest tickets) on conventional paper is limited by what can be printed on the front and back surface of the paper. This problem can be better understood by a review of conventional paper.

Conventional Paper

Conventional paper is a thin, matted or felted sheet, usually made of cellulose fibres, formed on a wire screen from water suspension. Typically the cellulose fibers are derived from wood (e.g., pine) or other vegetable pulp. When printing on typical paper, an ink or toner is applied and bonded to a surface of the paper. Application of the ink may be manual (e.g., writing with a pen) or automated (e.g., printers, copiers, faxes, etc.).

Poster Printing

Posters are typically larger than a standard 8.5 inch×11 inch piece of paper. As a result, posters must be printed on expensive printers that are capable of printing on larger sheets of paper. The result is that printing a poster is significantly more expensive per unit area than printing on a standard 8.5 inch×11 inch piece of paper.

Game Cards

Some contests (e.g., lotteries and promotional contests) make use of a printed card which has some portion of the card obscured by some material. To participate in the contest, the participant must scratch off the obscuring material to reveal the printed portion of the card below the obscuring material. However, a game card printed on conventional paper is limited by what can be printed on the front and back surface of the paper.

### SUMMARY OF THE INVENTION

Embodiments of the present invention are directed to a method and apparatus for layered printing. In one embodiment, printing is performed on a leaf of layered paper. In one embodiment, the leaf of layered paper is approximately the same thickness as a conventional sheet of paper commonly used in the printing application (e.g., business card thickness, typewriter page thickness, etc.). The layered paper is similar in appearance to conventional paper and has the ability to bond with ink or toner. In one embodiment, layered paper is formed by the layering of two or more thin layers of paper-like or plastic-like sheets. The characteristics of a sheet of layered paper include flexibility and low elasticity.

In one embodiment, three thin sheets of Mylar-like plastic are coated on a side, termed the “back side”, with a non-hardening adhesive. In one embodiment, the three thin sheets are stiffened internally by a microscopic weave. In another embodiment, the three thin sheets are stiffened by a stiffening structure of ultra-fine carbon-fibers spaced internally through the body of the plastic sheet. In one embodiment, the three thin sheets are coated on one side with a non-hardening adhesive. The adhesive is similar to adhesives used on notepad paper to make the notes removable, replaceable and postable. Each thin sheet is bonded to the next by the adhesive coated side. In one embodiment, the last sheet is bonded to a conventional, lightweight, paper backing sheet by the adhesive coated side.

In one embodiment, the front surfaces (i.e., the surfaces not coated with an adhesive) of the thin, plastic sheets are made absorbent to ink. In one embodiment, the front surface is made absorbent to ink through an etching process. In another embodiment, the front surface is made absorbent to ink through a coating process. In other embodiments, the front surface is made absorbent to ink by other means. The final assembly looks, feels and bonds with ink like a sheet of conventional paper.

In one embodiment, each layer of a layered sheet is constructed of clear plastic. In other embodiments, each layer is constructed of other transparent and flexible materials. As a result, the layered sheet is clear. In another embodiment, one or more layers of a layered sheet are opaque. In yet another embodiment, one or more layers of a layered sheet are tinted. In still another embodiment, one or more layers of a layered sheet are clouded. In one embodiment, a portion of a layer is transparent. In another embodiment, a portion of a layer is opaque. In yet another embodiment, a portion of a layer is tinted. In still another embodiment, a portion of a layer is clouded.

In one embodiment, one or more layers of the layered sheet are made selectively porous to allow the applied ink to migrate through to deeper layers. In another embodiment one or more layers are made to hold ink impermeably. In one embodiment, a portion of a layer is porous. In another embodiment, a portion of a layer holds ink impermeably. In one embodiment, permeability and opacity/clarity characteristics are selectively created in defined regions of each layer of the structure to produce complex print-through and peel-off effects.

In one embodiment, layered sheets are used to produce the signifier recording cards disclosed in U.S. patent application No. 09/896,838, filed Jun. 29, 2001 incorporated herein by reference. In one embodiment, layered sheets are used for the layers of the described signifier recording cards. In another embodiment, a single, layered sheet is used to make a signifier recording card.

In one embodiment, a layered sheet is used to print-out credits/debits in any form. The credits/debits and ancillary information of any kind are rendered invisible by one or more techniques. In one embodiment, a porous, opaque top layer accepts ink and passes the ink through to the layer below. Thus, the printed information on the layer below is obscured until the top layer is peeled off. In another embodiment, a clear top layer is printed with a barcode (or optically-sensed codes called ‘2D’ codes), OCR, credit information or other information. The layer below the clear top later is the same color as the printing. Thus the printing is obscured until the layer below is peeled away. In yet another embodiment, the layer below the clear top later is otherwise selected to obscure the printed matter until the layer below is removed.

In one embodiment, the method of bonding together the layers of the layered paper enables two layers to be reattached after being peeled apart. In another embodiment, once two layers are peeled apart, the layers cannot be bonded together again.

In one embodiment, layers are peeled at the point of redemption of credits. A barcode, signifier string or similar item is created by the overprinting of partial patterns or sequences over patterns printed on the backing layer of the structure.

In one embodiment, layered paper is used to allow the ‘test-printing’ of registration-critical information numerous times before committing to a final print pass. In one embodiment, the backing layer contains the printed information defining the borders and/or registration marks of a series of labels. The die-cutting for such labels is partially cut through some of the layers of the structure. Thus, the registration is refined by performing one or more test printing passes in a user's printer. After the test passes, the top layers with the result of the test pass printing are peeled away or otherwise removed. The registration is adjusted based on the results of the test pass printing to allow a perfectly registered print to be made on a lower layer of the structure or onto its backing layer.

In another embodiment, a layer of the layered paper is formed of a substance that is dissolved by the solvent or carrier liquid of the printers' ink. In one embodiment, the top layer is held together by a micro-mesh of fibers. Thus, peeling away the layer leaves an embossed printed surface. In other embodiments, other modified print treatments (e.g., metalized, glitterized, magnetic coated, fluorescent, day-glo, PMS-color matched, conductive, etc.) are used.

In one embodiment, an iron-oxide power, or other similar magnetic substance, is added to the upper layers of the layered paper. Conventional printing results in magnetizable surfaces magnetically readable characters in the lower level of the layered paper once the upper layers are removed. In one embodiment, the magnetic material is pre-magnetized in a uniform direction. Thus, bonding the magnetic substance and removing the original contiguous overlay results in a readable magnetic stripe. In one embodiment, data is written to the layered paper by printing narrow bands of normal ink. Thus, the spatial analog of a spot-magnetized contiguous stripe is created. In another embodiment, two stripes are created of opposite polarity to implement bi-directionally magnetic stripes.

In one embodiment, layered paper is removably placed in a notebook (e.g., a notebook organized for personal planning purposes). A sheet of layered paper in the notebook is formed in regions. In one embodiment, the regions are narrow bands of alternating color or hue. In another embodiment, each band is peelable by means of a small tab. In various embodiments, the bands correspond to times of day, phone numbers to be called or items on a to-do list. As each item is accomplished, the band on which the item is printed is removed. Thus, an empty band is exposed for new tasks. In one embodiment, the final layer is alternately colored to indicate the end of peelable layers. In this way, a single sheet of layered paper records notes or tasks and accommodates revision and change without recopying of the other items.

In one embodiment, no adhesives are used to bond layers of layered paper together. In another embodiment, adhesives of limited use are used to enhance the characteristics of layered paper that uses no adhesives. In one embodiment, adhesives similar to adhesives used on notepad paper to make the notes removable, replaceable and postable are used together with an adhesive having a self-aggregating tendency when released from the zone between two sheets in order to make re-application of the adhesive impossible. In one embodiment, authenticating symbols (e.g., identifiable signatures, seals, watermarks and codes, or other selected information) are embedded into the adhesive beneath a clear, tinted, frosted, or translucent layer. Thus, authenticating symbol is visible through the top layer. The adhesive is chosen such that the integrity of the adhesive or of the superimposed or interjected imagery is destroyed upon peeling or lifting apart the layers held by the adhesive.

In one embodiment, one or more layers of the layered paper have compressible surfaces with a very high coefficient of static friction when under compression. In one embodiment, the compressible surfaces are made to join semi-permanently or permanently by various chemical or adhesive coatings.

In one embodiment, interlocking structures on facing surfaces are used in a sheet of layered paper. In another embodiment, a randomly-textured binding surface is structured so that, upon application of surface pressure, the textural elements of the surface tend to lock together. In one embodiment, surfaces of layers are made compressibly binding by canting the walls of a randomly-sp aced ‘grain’ element in such a way that the grain presents an undercut profile (mushroom-like or keystone-like) where the width of the average top, or presenting, surface of the grain-element is slightly larger than the average distance between grain elements. In one embodiment, grain element are positioned in a pattern (e.g., equi-spaced hexagons) rather than randomly. Other embodiments use grain elements with other interlocking geometries.

In one embodiment, a stochastic margin of error is allowed in the actual interlocking of grain elements across planar layers. In one embodiment, there is a direct spatial alignment of near microscopic pores and studs across part of two interlocking layers. In another embodiment, the mushroom-to-undercut-cup linkage realized in a nano-tech, or micro-scale, way causes a layer to appear to be a gently granular surface imparting a milky quality to a clear plastic sheet. The grain elements are made of materials that are sufficiently elastic to interlock tightly by mutual compression. Thus, the top of a grain on a first layer fills the space between the bottoms of two grains on a second layer. If the two layers are made of materials with identical refraction indices, the two layers become clear when the first layer is bonded to the second layer.

In one embodiment, exposed surfaces of layered paper in which surfaces have interlocking elements need not be protected from contact with hands, printer mechanisms and the like because the surfaces are not adhesive coated. In one embodiment, geometries are used to cause the interlocking seal of the opposing layers to be sufficiently durable as to be permanent. In another embodiment, geometries are used to cause the interlocking seal of the opposing layers to be sufficiently durable as to be releasable only by making the “stem” portion of a mushroom-like stud sufficiently thin to break off when the sheets were caused to be peeled apart.

In one embodiment, breaking the stem portion of a grain element to separate two layers renders the separation irreversible. Such irreversibility is of great importance in such applications as gaming. In one embodiment, once separated, two layers (e.g., an obscuring layer on a game card) cannot be reattached.

In one embodiment, solvents or adhesives are applied within the binding region of the stud-and-cup devices. In one embodiment, a microscopic, “hairy” surface (i.e., a surface with thin filaments projecting therefrom) of one layer is bonded by solvents or adhesives to another layer such that the microscopic hairs tear away upon separation of the layers. In other embodiments, the projecting structures have alternative geometries.

In one embodiment, substances that alter the appearance of surfaces (e.g., from clear to a visible color, texture, or density) are micro-encapsulated in the stems such that the encapsulation ruptures when layers are separated. In another embodiment, substances that alter the appearance of surfaces are micro-encapsulated adjacent to the bonding-regions of an interlocking stack of layers such that the encapsulation ruptures when layers are separated. In various embodiments, the encapsulated substances are dyes, inks, heat or solvents.

In another embodiment, grain elements are made from materials that shift appearances when stretched or sheared. In one embodiment, grain elements contain a clear plastic ‘stem’ or ‘hair’ that stretches and disrupts the clarity of the stem, rendering it milky, as it stretched and then broken. The resultant surface of a layer after separation is subtly flocked and whiteish.

In one embodiment, two layers have bands defined on their surfaces, using varying geometries of grain elements. Thus, interlocking is only possible with sufficiently accurate registration. In one embodiment, size of a manually-oriented operation is ¼ inch. Varying binding schemes are employed across a ¼ inch band or region of the two binding surfaces. In another embodiment, two interlocking layers are to be interlocked by their edges by means of an overlap of ½ inch. There are two ¼ inch bands of dissimilar grain elements. Thus, the grain elements interlock only after they are accurately aligned. In one embodiment, a linear array, such as a linear projecting bead or wall received between two mating projecting walls, is used to ensure two layers bind only in a particular configuration.

In one embodiment, parallel bands of adhesives are separated by a manually-scaled distance. Guide marks (e.g., registration marks or a registration line) guide a user to the appropriate place in which to press layers together. In one embodiment, such bands are marked with registration lines that are obliterated by erasing, dissolving, bleaching or other substances upon the appropriate positioning and locking of the layers.

In one embodiment, one layer contains lines printed with an ink or dye that is rendered invisible by the application of a second substance. The second substance is micro-encapsulated in capsules laid down on the surface of a second layer in the appropriate registering position. In another embodiment, the second layer also has a registration line or marker printed using the “disappearing” ink, chemical or dye. The act of accurately positioning and pressurizing the two layers or surfaces ruptures the solvent/ink-dissolving or dematerializing agent. The successful alignment of the two surfaces is assured and the alignment marks are rendered invisible.

In another embodiment, the surface of a layer or of its coating contain visible registration marks or other such indicators caused by the grain elements. A second layer contains a similar registration mark. In one embodiment, when the registration marks are aligned and interlocked, the surface is rendered smooth by the optical joining of complementarily grain elements. In another embodiment, when the registration marks are aligned and interlocked, the surface is rendered invisible by the wetting action of a micro-encapsulated substance (e.g., a solvent) that clarifies the layers. In one embodiment, the encapsulated substance fills small voids or perforations that form the registration markers.

In one embodiment, layered paper is used for printing large graphics (e.g., posters). Layered paper is created in a standard size and shape agreeable to a printer. In one embodiment, 8.5 by 11 inch sheets of layered paper are created. In various embodiments, the sheets are made to affix to one another by any of several means, including those described above for binding layers of layered paper together.

In one embodiment, software spreads a computer/copier-contained image across multiple sheets of layered paper. In one embodiment, a standardized image size and family of orientations (e.g., 4 by 4 sheets, 3 by 6, and 2 by 2) is integrated into the software.

In one embodiment, an image (pre-divided and prepped) is provided to users/consumers (e.g., by the Internet or as an add-on to such media as CD's and DVD's). In another embodiment, software is distributed that enables a user to reliably condition an image provided by the user or third-party for printing over an array of layered papers. In one embodiment, the software, in addition to computing the boundaries and borders of an image, is equipped with the ability to calculate seamless “feathered” borders to conceal the juncture of the dispersed imagery.

In one embodiment, sheets of layered paper are optimized for joining together into a contiguous whole. In various embodiments, the layered sheets are coated, molded or otherwise optimized around their borders for mutual adherence as described above. In one embodiment, a region of mutual overlap between adjacent sheets is established. In one embodiment, the layered paper is opaque like conventional pulp paper, and the region of mutual overlap is a border (e.g., a border ½ inch in width). In one embodiment, the border is of uniform width. In another embodiment, the width of the border is varied to produce a pattern (e.g., interlocking teeth).

In one embodiment, sheets of layered paper are formed in two thickness layers such that the thickness of the border is half of the total thickness of the rest of the sheet. In one embodiment, the half-thickness border areas are covered with a removable shielding frame. In one embodiment the thickness of the shielding frame is also half of the total thickness of the rest of the sheet. Thus, the border and shielding frame combined are the same thickness as the rest of the sheet.

In one embodiment, large images are printed across a plurality of sheets of layered paper. Two adjacent layered sheets are printed such that the recessed borders of one sheet faces the printing mechanism of a printer and the recessed borders of the adjacent sheet faces away from the printing mechanism. Upon removing the shielding frame, the borders of two adjacent sheets are joined by any of the above methods (e.g., adhesive, interlocking geometries) to form a composite image across the boundary of the two sheets. Since the thickness of the borders of each sheet is half the total thickness of a sheet, the thickness of the joined borders is the thickness of the total sheet. Thus, the thickness of the composite image is uniform.

In another embodiment, one sheet of layered paper displays the image-section entirely on an opaque surface. Another portion of the image resides on an opaque surface with a clear, image-bearing overlay in the border section of a second sheet. In one embodiment, the layered paper is a printable plastic sheet overlaid on a paper backing in such a way as to effect removal of the border to expose only the clear region. In one embodiment, the areas of interlock are reduced to half of the area of overlap. For example, in a 1 inch border ½ inch is structured as the interlocking area of reduced thickness described above. The other ½ inch is feathered slightly so that the central printed area of the fully opaque sheet is slightly overlapped by a clear border on a printed area of another sheet.

In one embodiment, removable borders are formed on standard-size sheets. Printing is extended to the border, allowing bleeds or near-bleeds to be printed. In one embodiment, an assembled composite image has a clear overlay that covers ½ inch of printed area on the opaque sheeting. In one embodiment, software re-sizes and distributes the image across an array of sheeting and feathers the printing of the clear overlays in such a way as to cause a mathematically-perfect summation of the image-borders upon overlap. In other embodiments, clear or translucent registration sheets and positioning aids are used.

In one embodiment, layered sheets used in printing composite images have removable/peelable layers that are used by a user to arrive at accurate registration of the individual elements of the composite image. In another embodiment, a single clear layer of plastic of sufficient thickness to retain dimensional stability is imprinted with a section of image. In one embodiment, the layer is imprinted while attached to a substrate layer. After printing, the imprinted layer is peeled away from the substrate layer. In another embodiment, the layer is imprinted while not attached to another layer. The imprinted layer is applied to a substrate layer having accurate registration marks. In one embodiment, the accurate registration marks are in removable border-zones of other layered sheets. In one embodiment, the registration marks are made disappearing by any of the methods described above.

In one embodiment, the substrate sheets are interlocking sheets of layered paper. In one embodiment, the substrate sheets are interlocked before the imprinted layer is attached. In another embodiment, imprinted layers are attached to substrate sheets before the substrate sheets are interlocked.

In one embodiment, layered paper for creating composite images is provided to a consumer by means of conventional retail channels. In another embodiment, layered paper is provided to a consumer by means of advertising programs (e.g., placing layered sheets into publications, mailings and the like).

In one embodiment, the printable clear layers are mutually adherent. In one embodiment, the clear layers are optionally applied to a transparent, translucent or opaque backing panel. In one embodiment, the backing panel is composed of layered sheets. In another embodiment, the backing panel is assembled by another means. In one embodiment, translucent backings are rear illuminated. In another embodiment, a printable layer with a removable/permanent backing is attached to a window glass.

In one embodiment, layer paper pre-bordered with an adaptive contour is made with no inherent provision for mutual adherence. An adhering substance is attached (e.g., rolled-on, taped, or otherwise applied) to the bordering regions. In one embodiment, a matching set of binding topographies is supplied because of the extremely small thicknesses required for a micro- or nano-manufacture of the binding topographies. In one embodiment, the binding topographies are ball and orifice types, and are supplied in rolls of male and female tape (i.e., elongated, relatively narrow sheets) able to be dispensed from a traditional tape dispenser. In one embodiment, the tape dispenser holds both types of tape.

In one embodiment, the “tape” is manufactured in a “hermaphroditic” design that intermixes both male and female elements in such a way that an effective number of male/female couplings are achieved to effect a suitable adhering of two surfaces. In various embodiments, hermaphroditic binders are made in a variety of scales, depths and bonding strengths. In one embodiment, hermaphroditic binders are evenly spaced mushroom-like “knobs” on stems. In one embodiment, the distance between knobs is greater than the stem diameter, and less than the knob diameter. In another embodiment, the height from the mounting surface to the underside of the knob is slightly greater than the depth of the knob.

In one embodiment, the tape is adhered using an adhesive that is stronger over a short (pull-apart) time than the strength of the hermaphroditic binding force. In another embodiment, a quick-drying viscous material (e.g., a solvent-immersed plastic) is made to form into a binding geometry (e.g., curling hairs or knob-like protrusions) by being pulled away from a suitable barrier at the approximate moment of dispensing of the tape. Upon swiftly hardening, these binding geometries are inclined to entangle upon mutual contact. Thus, a removable/releasable tape or surface or strip is formed.

In one embodiment, layered paper is used to allow the creation of value-added spaces and/or perceived value-added spaces in the traditional print-publication world. In one embodiment, layers are printed in isolation. In one embodiment, stiffening substrates are used in printing. In another embodiment, stiffening implants are used in printing. In one embodiment, after layers are printed in isolation, the layers are formed together by means of a registering and pressure-applying device. In one embodiment, the registering and pressure-applying device is a multiple registered feed device that feeds the layers to pressurizing rollers wherein each of the multiple feeds corresponds to a layer of the layered sheet.

In one embodiment, an underlying image is printed one a layer. An obscuring layer (e.g., opaque, clear or translucent layer, itself printed with blocking, opaque inks or translucent inks/dyes/colors and substances such as scratch-off layers or regions) obscures part of the underlying image. Thus, a user may reveal layers or regions with successive removals of top layers using layered paper. In another embodiment, layered paper is used to emulate the functions of the “windowed” signifier/gaming card described in U.S. Provisional Patent Application No. 60/215,444, filed Jun. 30, 2000, and incorporated by reference herein.

In another embodiment, layered paper printed with two layers is used to cause a second image to appear beneath a first in a sequentially-related way. In one embodiment, an advertisement appears on a second layer. Thus, advertisements are allowed to appear in previously off-limits areas. In another embodiment, an element that is less than desirable in the long-term (e.g., an advertisement) is only on the topmost peelable layer. In one embodiment, a second layer is partially visible through the top layer. The partially visible material is sufficient to pique the interest of the viewer to remove the top layer. Advertising (or other obscured elements) are revealed or initially-displayed in an altered form not simply there or not there, in one embodiment. Thus a large logo might appear on a poster along with advertising copy. Upon peeling of the paper-like film only a small logo might be displayed that is suitable, for example, for wall display of a poster.

In another embodiment, the second layer also contains information (e.g., advertising) that a sponsor wishes the viewer to see. In one embodiment, a magazine cover printed with layered paper depicts a starlet. The depiction is printed on the top layer of the layered paper. On the next layer, the same starlet appears scantily clad and wearing the advertiser's jogging shoes. In one embodiment, part of the image of the scantily clad starlet shows through the top layer. The top layer is imbued with some obscuring material so that part (e.g., a region containing areas of interest to the reader) of the unclad figure on the lower layer is obscured.

In one embodiment, layered paper is used in incentive applications (e.g., gaming or coupons). In one embodiment, some of the contents of lower layers are key to the titillating aspect of an incentive device (e.g., a gaming card or a coupon) device. In one embodiment, symbols (e.g., signifiers, numbers, images and shapes) are distributed across the layers for the purpose of enticing a consumer with the promise of real or imagined rewards.

In one embodiment, a sheet of layered paper is printed on the back surface. In one embodiment, the back surface is a porous film of plastic. The interior of the back film is a fibrous paper or paper-like synthetic. The fibrous members of the interior fiber are made available (e.g., by being caused to extend) to the pigments (e.g., inks, dyes and the like) applied to the porous, non-absorbent backing film. In one embodiment, the pigments are pulled into the interior fibrous layer by capillary attraction. Once in the interior fibrous layer, the pigments affix themselves and form an interior image below the front sheet of the printable plastic film.

In one embodiment, the rear-introduced images would be obscured from a front view, by means of opaque adhesives. In other embodiments, similar means, are used to obscure the rear-introduced images from a front view. In another embodiment, the image is similarly obscured from a rear view by use of an opaque backing sheet. In one embodiment, the sheet of layered paper with the rear-introduced image is inserted into a conventional printing device for printing of a front image after the rear-introduced image is printed. In another embodiment, the rear-introduced image is printed after the front image.

In one embodiment, additional layers (e.g., front and back layers) accommodate registration techniques. In another embodiment, additional layers accommodate preprinted elements. In one embodiment, layered paper is used for the internal elements of a to-be-assembled element (e.g., a ticket or a coupon). In one embodiment, the internal elements are formed (i.e., preprinted) with visible elements (e.g., promotional codes and symbols). In another embodiment, the internal elements are formed with machine-readable elements.

In one embodiment, layered paper is used to assemble an item of real or perceived value (e.g., a coupon, a ticket, a check or a game piece). The item is broken into two or more parts. In one embodiment, four parts are spread throughout a publication. In other embodiments, the parts are spread throughout any of many content delivery options (e.g., several publications, across multiple issues of the same publication, etc).

In one embodiment, upon assembly of all the parts, a pattern (e.g., a signifier string) emerges. In another embodiment, the reward is inherent in the assembled device itself (e.g., a coupon). In one embodiment, the assembled device is a ticket to an event. In another embodiment, a user is required to interact in some way to validate the ticket to discourage theft of ticket elements from an unsold publication. In one embodiment, the ticket is assembled or placed upon a printable size sheet of paper in its final embodiment. Then, the ticket is placed in a printer and/or scanning device for a final addition of a validating code or image to be impressed upon it prior to the user spending its value. In one embodiment, identifying information (e.g., subscription codes) is encoded into one or more of the signifiers. In one embodiment, the assembly of the ticket involves authentication practices. In this embodiment, the ticket can not be used anonymously.

In one embodiment, a magnetic stripe (e.g., a legacy credit-card stripe) is duplicated by the selective transfer of pre-magnetized material using one of the printing methods described above. In one embodiment, a thin magnetized layer of material is released by the direct action of an ink solvent of a conventional printer. In another embodiment, a thin magnetized layer of material is released by the direct action of sequestered solvents encapsulated in a sequestering device (e.g., a capsule). The sequestering device is soluble by the ink solvent or carrying medium.

In one embodiment, a second credit card stripe is provided (e.g., on the reverse side of a card made of layered paper) to accommodate additional recorded data. In one embodiment, layered paper is used to locally create cards having magnetic stripes (e.g., credit card stripes or bank-card stripes).

In one embodiment, dual polarity magnetic stripes are printed on layered paper. In one embodiment, a substrate (magnetic stripe) layer is printed and a registered magnetic-bearing layer of opposing polarity (direction) is placed over the created stripe. Then, the top layer is selectively transferred to the substrate layer (e.g., by ink solvents) to form a dual polarity magnetic stripe.

In another embodiment, a magnetic stripe of opposing or enforcing polarity is placed onto the backside of the layered paper in registration with a magnetic layer printed to the front side. In one embodiment, the thickness of the card material is minimized in the magnetic stripe region (e.g., one or more layers are removed to form a channel. The rear-applied field bearing material has a proportionally increased field strength, thickness and size to create a balanced bi-polar field in the front “reading” area.

In another embodiment, a template is provided in the general form of a credit/debit card with the appropriate standard spacings and width with relation to the stripe and the card's edge. In one embodiment, the card is imprinted with additional data and/or imagery. In one embodiment, the multiple layered paper construction encompasses only the region of the stripe's application, leaving other areas free to accept normal inks, or other forms of ink (e.g., decorative metallized layers). In another embodiment, layered paper encompasses more than the region of the stripe's application.

In one embodiment, cards bearing user credits (e.g., a credit card) are created with a printed and fixed face-value. In one embodiment, a user converts his or her credits to a fixed-value spendable credit. In another embodiment, the card is used as a phone “calling card”. In one embodiment, credits are obtained by participating in a program that provides such credits. In another embodiment, credits obtained for various media consumption (e.g., through other programs) are converted into a credit freely dispensable and applicable to unrelated areas of purchase. In one embodiment, such credits are collected and dispersed entirely in cyberspace.

In one embodiment, a card reading device (monetary/credit/debit card reader or barcode reading device) is modified to function as a card writing device. In another embodiment, card reading/writing devices are manufactured that function both as card readers and as card writers. In one embodiment, writing is accomplished by any means (e.g., optical, magnetic, chemical, crystalline, mechanical and electronic means). ATM machines, credit card readers, barcode scanners and the like have not typically been points of writing for users. In one embodiment, credits are altered (e.g., added, removed or transferred) on cards containing layered paper using non-traditional writing means (e.g., ATM machines, credit card readers and barcode scanners).

In one embodiment, a user provides transaction information (e.g., information indicative of coupon earnings, returned change, or specific credit/cash sums) on cards printed on layered paper (e.g., face-value cards). In another embodiment, transaction information is sent cybernetically from a card reading device to the user's on-line repository. In one embodiment, the on-line repository is an account (e.g., merchant or personal) accessible on-line. In an example embodiment, money saved from an airline ticket refund or discount program is routed automatically and/or volitionally to pay for other items (e.g., groceries or clothing) directly. In one embodiment, items are charged at full-price and a portion of the sales costs is redistributed directly to another purpose. In another embodiment, the redistribution is made through an intermediary device of a promotional credit system.

In another embodiment, isolated strips of binding materials (e.g., the above described tape or binding layers) are placed across the surface of printable layered paper. The layered paper is later used (e.g., folded and/or attached to additional sheets or other devices) to form composite articles (e.g., booklets, DVD cases or other containers and other useful articles) from standard printable templates.

In various embodiments, such templates are provided by a number of means. In one embodiment, the standardized software and/or industry-standardized DVD, CD or Flash-card artwork used to print packaging and/or labeling for a purchased (or downloaded) media product is downloaded from a website. In another embodiment, the standardized software and/or artwork is e-mailed to a consumer. In one embodiment, the cost of a blank is borne by advertisers or sponsors. In one embodiment, blanks are provided preprinted with messages. Space for the preprinted messages is statically or dynamically allocated by the to-be-downloaded artwork. In another embodiment, the messages might arrive with the artwork.

In one embodiment, a code or message is entered into the user's receiver/computer. The code is provided by (i.e., printed on) the printing blanks. In one embodiment, rewards (e.g., lotteries) are offered at the point of download. In one embodiment, an offered reward profitably interacts with material appearing on the pre-printed blanks. In another embodiment, the offered reward interacts with material appearing on the artwork.

In one embodiment, different pieces or aspects of a composite product (e.g., quadrants of a poster) are obtained from multiple sources (e.g., different websites, virtual locations, purchases, or participations). In another embodiment, a consumer is given several levels of ad-sponsorship from which to choose. The price is set between a floor price and a full-retail price dependent upon the level selected. An enabling device (e.g., a code) is granted after a level is chosen. In one embodiment, downloadable artwork as described above is provided in the basic download or purchase cost.

In one embodiment, markings (e.g., barcodes) are made discoverable through the use of layered paper. In another embodiment, markings are made removable through the use of layered paper. In yet another embodiment, a barcode is made relocatable through the use of layered paper. In one embodiment, markings are aggregated and/or interact to create a reward (e.g., credits or entries in lotteries). In another embodiment, the removal of a barcode element reveals incentivizing elements (e.g., gaming information) beneath the markings (e.g., codes, watermarks or price-stickers). In one embodiment, a revealed element contains a part of a marking (e.g., an image, series or code) that leads to a reward (e.g., entry into sweepstakes or multiplication of credit due to the consumption or purchase of synergistic products or services.

In one embodiment, layered paper is used to encapsulate or house openable or ruptureable elements. In one embodiment, layered paper is printed with normal page content. The layered paper also contains visual layers and peel-off zones that visually tie an entrapped substance (e.g., scents and scent-capsules) with surface-printed matter. Removing the peel-off zones releases the entrapped substance.

In another embodiment, layered paper contains (i.e. through micro-encapsulation or creation of regions in which bound or loose materials are sequestered) samples of products (e.g., powders, pastes, creams, spreads, and even liquids). In one embodiment, as ample is sequestered within a region of layered paper. In another embodiment, the sample is sequestered within entire layers of layered paper. In one embodiment, a make-up and cosmetic free ‘nite-out’ kit is sequestered in layered paper.

In one embodiment, elements similar to bandages with pre-provided adhesive tape are formed into (or bound onto) a paper-like sheet. The sheets of bandages are bound into folios to be packed and transported. In another embodiment, bandages made using layered paper contain (in micro-encapsulation) reactive chemicals. In one embodiment, the reactive chemicals produce an endothermic reaction when released. In another embodiment, the reactive chemicals produce an exothermic reaction when released. In one embodiment, the act of peeling a bandage's adhesive-protection backing releases the reactive chemicals. In another embodiment, the reactive chemicals are released by removing the strips from a protective backing. In other embodiment, other physical manipulation (e.g., crushing, pressurizing, stretching or folding) is used to release the reactive chemicals.

In one embodiment, the surface of a layer that is inherently non-absorbent to pigment (ink, toner, etc.) is made absorbent to pigment. In one embodiment, the surface is coated to make it absorbent. In another embodiment, the surface topography is altered to make the surface absorbent. In another embodiment, the surface is embedded with surface materials to make the surface absorbent. In an example embodiment, a coating of micro-capsules formed of a substance soluble by the base of the anticipated ink or pigment contains an accepting layer consisting of a porous cellulose fiber in a binder. In one embodiment, the binder does not penetrate the cellulose, and is activated only upon release and/or mixture with the applied ink or pigment base.

In another embodiment, a cellulose fiber (or its synthetic or bio-engineered/nano-engineered analog) is placed within (i.e., woven into, bonded into or placed in micro-pores within) the surface of the ink-accepting surface. In one embodiment, microscopic (e.g., etched, molded or heat-induced) pores form pockets containing microscopic ink-accepting items (e.g., fibers, chemical substances or powders) incorporated into the ink-accepting surface.

In another embodiment, substances having therapeutic uses (e.g., antibiotics, analgesics, disinfectants, hydrogen peroxide, zinc oxide, aloe vera extracts/juices, Lidocaine, etc.) are sequestered in layered paper used to make bandages. In one embodiment, the substances are sequestered within the removable (e.g., peel-away, break-away or tear-away) covering for the dressing portion of the first-aid strip or bandage. In one embodiment, the substances are kept sealed from contact with the air and from mutual contact. Thus, the release of substances and combinations of substances that are inherently unstable once deployed is enabled.

In one embodiment, wall coverings (e.g., wall paper) are made from layered paper. The coverings are created in a seamless fashion using overlap and/or the technology of registration and interlocking as described above.

In one embodiment, layered paper is used for exposed applications (e.g., covers of printed material, product packaging, on an outer surface of a product or on a section of any of the foregoing). In another embodiment, layered paper is used to provide simple peelable covers or packaging or regions thereof. In various embodiments, the peelable packaging is used on magazines, books, calendars, greeting cards, manuals, brochures and the like. In one embodiment, the layered paper is used for the purpose of enhancing in any real or perceived way, the value of the item.

In an example embodiment, the outer layer removes to reveal information (e.g., an advertisement and/or promotional/gaming/couponing/barcoding and similar items) on the covers of publications or other items. In various other embodiments, layered paper is applied to packaging, surface finishes of material goods, and any visible region of products. In one embodiment, the surface of a product (e.g., a CD, DVD, the packaging of software or the cover or similar surface (e.g., a software manual or training program)) bears signifier strings/images that, when appropriately removed by such methods as are described in U.S. Provisional Patent Application No. 60/215,444, filed Jun. 30, 2000, incorporated herein by reference, generate a reward (e.g., a toll-free support number or URL) only when the appropriate removal (e.g., in insolated segments) is performed. In another embodiment, layer paper is provided on a product or packaging for a product (including software on media) that, when removed in a proper manner, results in furnishing of information that enhances the value of the product or provides items of value to an owner or user of a product.

In one embodiment, a porous overlay layer that allows one ink (e.g., black ink) to penetrate through, or deeply into its structure is provided. The porous overlay is, then, caused to react only with an ink of another color. The reaction causes the selective binding of the overlay layer to that ink. Thus, a removable obscuring layer is created above the underprint. In various other embodiments, additional treatments (e.g., flocking, scratch-off obscuring layers, embossing, etc.) are applied by printers that have no special inks or feeder mechanisms. In one embodiment, a coating is provided containing sequestering elements (e.g., dissolvable capsules, honeycombs, similar sequestering elements or, in the case of impact printers, shatterable capsules or similar elements) wherein the sequestered substance binds to the inked areas when released. In one embodiment, the binding layer is peeled off, or brushed away manually. In another embodiment, the printed area of the binding layer is caused to raise-up in the style of embossing.

In another embodiment, non-standard sized sheets (e.g., extremely large or small sheets) of layered paper is manufactured. In one embodiment, billboard size posters are created using layered paper.

### BRIEF DESCRIPTION OF THE DRAWINGS

These and other features, aspects and advantages of the present invention will become better understood with regard to the following description, appended claims and accompanying drawings where:

FIG. 1 is a block diagram of a sheet of layered paper in accordance with one embodiment of the present invention.

FIG. 2 is a flow diagram of the process of assembling a sheet of layered paper in accordance with one embodiment of the present invention.

FIG. 3 is a flow diagram of the process of assembling a sheet of layered paper wherein each layer is made absorbent to pigment in accordance with one embodiment of the present invention.

FIG. 4 is a flow diagram of the process of printing on layered paper in accordance with one embodiment of the present invention.

FIG. 5 is a flow diagram of the process of printing hidden and revealable information on layered paper.

FIG. 6 is a flow diagram of the process of redeeming credits in accordance with one embodiment of the present invention.

FIG. 7 is a flow diagram of the process of test printing in accordance with one embodiment of the present invention.

FIG. 8 is a flow diagram of the process of printing with ink that dissolves a layer in accordance with one embodiment of the present invention.

FIG. 9 is a flow diagram of the process of printing a magnetic stripe in accordance with one embodiment of the present invention.

FIG. 10 is a block diagram of the non-adhered surfaces of two layers that adhere using interlocking structures in accordance with one embodiment.

FIG. 11 is a block diagram of the layers of FIG. 10 adhered together in accordance with one embodiment.

FIG. 12 is a flow diagram of the process of binding and irreversibly peeling two layers in accordance with one embodiment.

FIG. 13 is a flow diagram of the process of binding layers in accordance with one embodiment.

FIG. 14 is a flow diagram of the process of printing a composite image on layered paper in accordance with one embodiment.

FIG. 15 is a block diagram of a simplified depiction of the method by which the interlocking of multiple-sheet paper panels is achieved in the specific instance of a multi-part paper for the purpose of standardized assembly of a poster, or poster-like oversize sheet showing no visible seams in a printed image spanning those seams in accordance with one embodiment of the present invention.

### DETAILED DESCRIPTION OF THE INVENTION

The invention is a method and apparatus for layered printing. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Layered Paper

In one embodiment of the present invention, printing is performed on a leaf of layered paper. In one embodiment, the leaf of layered paper is approximately the same thickness as a conventional sheet of paper commonly used in the printing application (e.g., business card thickness, typewriter page thickness, etc.). The layered paper is similar in appearance to conventional paper and has the ability to bond with ink or toner.

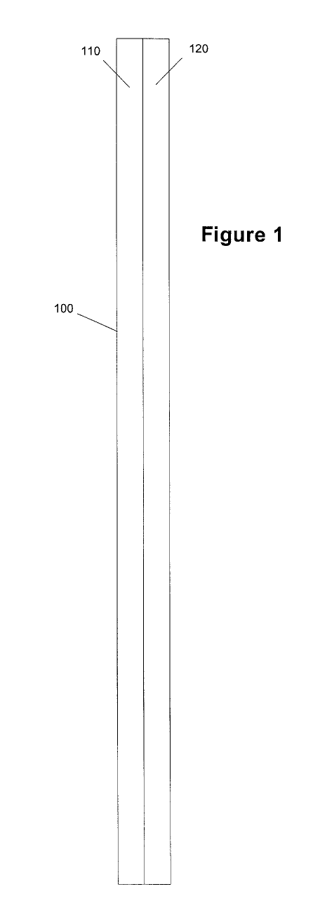

In one embodiment, layered paper is formed by the layering of two or more thin layers of paper-like or plastic-like sheets. The characteristics of a sheet of layered paper include flexibility and low elasticity. FIG. 1 illustrates a sheet of layered paper. The layered paper sheet 100 is composed of a first very thin layer 110 and a second very thin layer 120. The two layers are bonded together to form a sheet of layered paper that has the thickness of a conventional sheet of paper.

Layer Bonding by Adhesive

In various embodiments, layers are bonded to each other by an adhesive. In one embodiment, three thin sheets of Mylar-like plastic are coated on a side, termed the “back side”, with a non-hardening adhesive. In one embodiment, the three thin sheets are stiffened internally by a microscopic weave. In another embodiment, the three thin sheets are stiffened by a stiffening structure of ultra-fine carbon-fibers spaced internally through the body of the plastic sheet.

In one embodiment, the three thin sheets are coated on one side with a non-hardening adhesive. The adhesive is similar to adhesives used on notepad paper to make the notes removable, replaceable and postable. Each thin sheet is bonded to the next by the adhesive coated side. In one embodiment, the last sheet is bonded to a conventional, lightweight, paper backing sheet by the adhesive coated side.

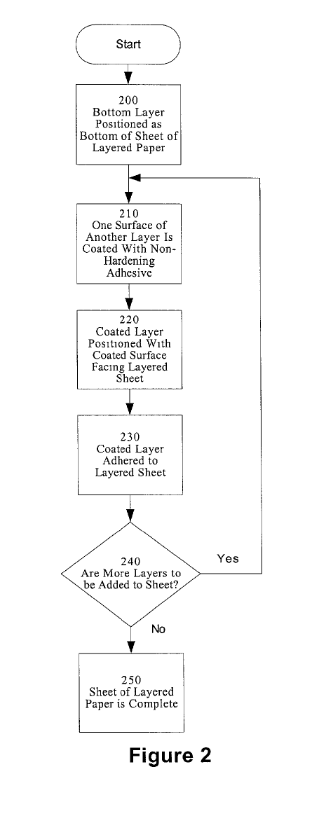

FIG. 2 illustrates the process of assembling a sheet of layered paper in accordance with one embodiment of the present invention. At block 200, a bottom layer is positioned as the bottom of the sheet of layered paper. At block 210, one surface of another layer is coated with a non-hardening adhesive. At block 220, the coated layer is positioned with the coated surface facing the layered sheet. At block 230, the coated layer is adhered to the layered sheet. At block 240, it is determined whether more layers are to be added to the sheet of layered paper. If no more layers are to be added, at block 250, the sheet of layered paper is complete. If another layer is to be added to the layered sheet, the process repeats at block 210.

Making Surfaces Pigment Absorbent

In various embodiments, the layers are made of substances in configurations that typically are non-absorbent to pigments. The layers are treated to make the layers absorbent to the desired pigment. In one embodiment, the front surfaces (i.e., the surfaces not coated with an adhesive) of the thin, plastic sheets are made absorbent to ink. In one embodiment, the front surface is made absorbent to ink through an etching process. In another embodiment, the front surface is made absorbent to ink through a coating process. In other embodiments, the front surface is made absorbent to ink by other means. The final assembly looks, feels and bonds with ink like a sheet of conventional paper.

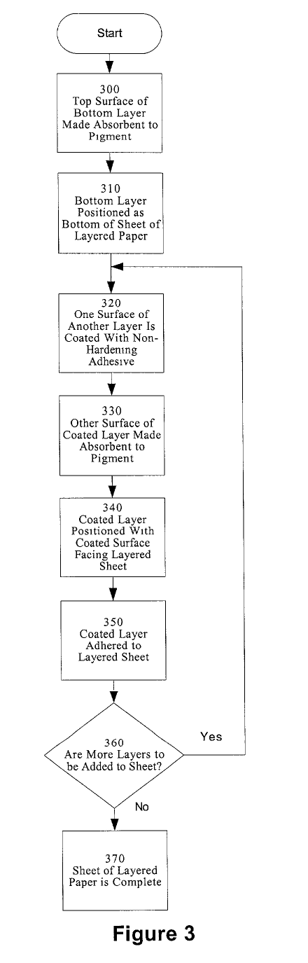

FIG. 3 illustrates the process of assembling a sheet of layered paper wherein each layer is made absorbent to pigment in accordance with one embodiment of the present invention. At block 300, a top surface of a bottom layer is made absorbent to pigment (e.g., ink). At block 310, the bottom layer is positioned as the bottom of the sheet of layered paper. At block 320, one surface of another layer is coated with a non-hardening adhesive. At block 330, the other surface of the coated layer is made absorbent to pigment.

At block 340, the coated layer is positioned with the adhesive coated surface facing the layered sheet. At block 350, the coated layer is adhered to the layered sheet. At block 360, it is determined whether more layers are to be added to the sheet of layered paper. If no more layers are to be added, at step 370, the sheet of layered paper is complete. If another layer is to be added to the layered sheet, the process repeats at step 320.

Layer Clarity

In one embodiment, each layer of a layered sheet is constructed of clear plastic. In other embodiments, each layer is constructed of other transparent and flexible materials. As a result, the layered sheet is clear. In another embodiment, one or more layers of a layered sheet are opaque. In yet another embodiment, one or more layers of a layered sheet are tinted. In still another embodiment, one or more layers of a layered sheet are clouded. In one embodiment, a portion of a layer is transparent. In another embodiment, a portion of a layer is opaque. In yet another embodiment, a portion of a layer is tinted. In still another embodiment, a portion of a layer is clouded.

Porous Printing

In one embodiment, one or more layers of the layered sheet are made selectively porous to allow the applied ink to migrate through to deeper layers. In another embodiment one or more layers are made to hold ink impermeably. In one embodiment, a portion of a layer is porous. In another embodiment, a portion of a layer holds ink impermeably. In one embodiment, permeability and opacity/clarity characteristics are selectively created in defined regions of each layer of the structure to produce complex print-through and peel-off effects.

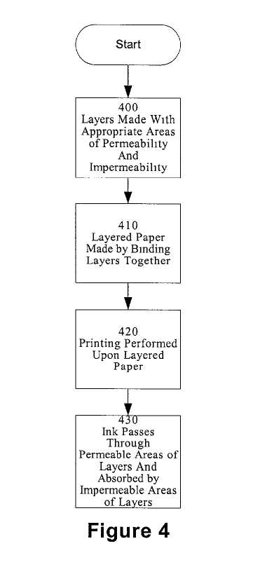

FIG. 4 illustrates the process of printing on layered paper in accordance with one embodiment of the present invention. At block 400, layers are made with appropriate areas of permeability and impermeability. At block 410, layered paper is made by binding the layers together. At block 420, printing is performed upon the layered paper. At step 430, ink passes through permeable areas of layers and is absorbed by impermeable areas of layers.

Printing Layered Paper for Reward Cards

In one embodiment, layered sheets are used to produce the signifier recording cards disclosed in U.S. patent application Ser. No. 09/896,838, filed Jun. 29, 2001 incorporated herein by reference. In one embodiment, layered sheets are used for the layers of the described signifier recording cards. In another embodiment, a single, layered sheet is used to make a signifier recording card.

In one embodiment, a layered sheet is used to print-out credits/debits in any form. The credits/debits and ancillary information of any kind are rendered invisible by one or more techniques. In one embodiment, a porous, opaque top layer accepts ink and passes the ink through to the layer below. Thus, the printed information on the layer below is obscured until the top layer is peeled off. In another embodiment, a clear top layer is printed with a barcode, OCR, credit information or other information. The layer below the clear top later is the same color as the printing. Thus the printing is obscured until the layer below is peeled away. In yet another embodiment, the layer below the clear top later is otherwise selected to obscure the printed matter until the layer below is removed.

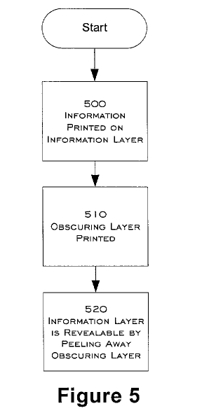

FIG. 5 illustrates the process of printing hidden and revealable information on layered paper. At block 500, information is printed on an information layer. At step 510, an obscuring layer is printed. At step 520, the information layer is revealable by peeling away the obscuring layer.

Peelable Layers

In one embodiment, the method of bonding together the layers of the layered paper enables two layers to be reattached after being peeled apart. In another embodiment, once two layers are peeled apart, the layers cannot be bonded together again. In one embodiment, layers are peeled at the point of redemption of credits. A barcode, signifier string or similar item is created by the overprinting of partial patterns or sequences over patterns printed on the backing layer of the structure.

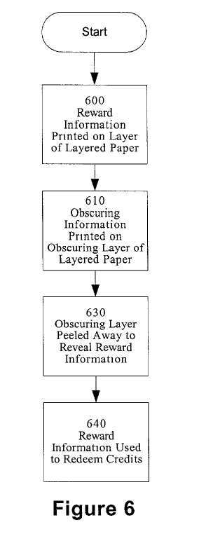

FIG. 6 illustrates the process of redeeming credits in accordance with one embodiment of the present invention. At block 600, reward information (e.g., a barcode or signifier string) is printed on a layer of a piece of layered paper. At block 610, obscuring information is printed on an obscuring layer of the layered paper. In one embodiment, the obscuring layer is an opaque layer. In another embodiment, the obscuring layer is transparent and is printed with markings that obscure the reward information on the information layer. At block 630, the obscuring layer is peeled away to reveal the reward information. At block 640, the reward information is used to redeem credits.

Test Printing on Same Layered Sheet

In one embodiment, layered paper is used to allow the “test-printing” of registration-critical information numerous times before committing to a final print pass. In one embodiment, the backing layer contains the printed information defining the borders and/or registration marks of a series of labels. The die-cutting for such labels is partially cut through some of the layers of the structure. Thus, the registration is refined by performing one or more test printing passes in a user's printer. After the test passes, the top layers with the result of the test pass printing are peeled away or otherwise removed. The registration is adjusted based on the results of the test pass printing to allow a perfectly registered print to be made on a lower layer of the structure or onto its backing layer.

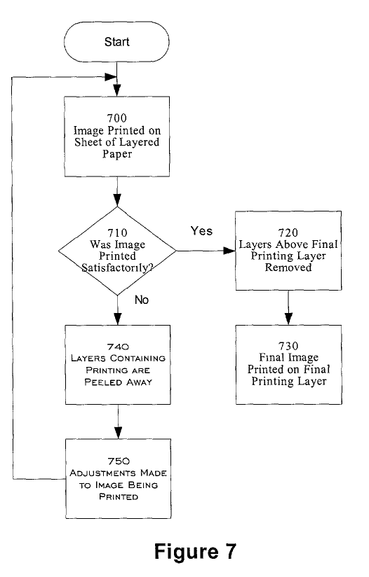

FIG. 7 illustrates the process of test printing in accordance with one embodiment of the present invention. At block 700, an image is printed on a sheet of layered paper. At block 710, it is determined whether the image printed satisfactorily. If the image printed satisfactorily, at block 720, the layers above the final printing layer are removed. At block 730, the final image is printed on the final printing layer.

If the image did not print satisfactorily, at block 740, the layers containing the printing are peeled away. At block 750, adjustments are made to the image being printed and the process repeats at block 700.

Printing Treatments

In another embodiment, a layer of the layered paper is formed of a substance that is dissolved by the solvent or carrier liquid of the printers' ink. In one embodiment, the top layer is held together by a micro-mesh of fibers. Thus, peeling away the layer leaves an embossed printed surface. In other embodiments, other modified print treatments (e.g., metalized, glitterized, magnetic coated, fluorescent, day-glo, PMS-color matched, conductive, etc.) are used.

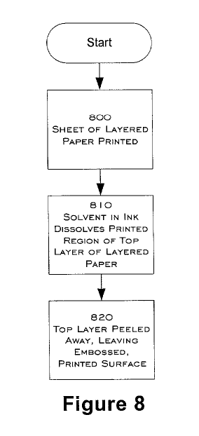

FIG. 8 illustrates the process of printing with ink that dissolves a layer in accordance with one embodiment of the present invention. At block 800, a sheet of layered paper is printed. At block 810, a solvent in the ink dissolves a printed region of the top layer of the layered paper. At block 820, the top layer is peeled away, leaving an embossed, printed surface.

Magnetic Printing

In one embodiment, an iron-oxide power, or other similar magnetic substance, is added to the upper layers of the layered paper. Conventional printing results in magnetizable surfaces magnetically readable characters in the lower level of the layered paper once the upper layers are removed. In one embodiment, the magnetic material is pre-magnetized in a uniform direction. Thus, bonding the magnetic substance and removing the original contiguous overlay results in a readable magnetic stripe. In one embodiment, data is written to the layered paper by printing narrow bands of normal ink. Thus, the spatial analog of a spot-magnetized contiguous stripe is created. In another embodiment, two stripes are created of opposite polarity to implement bi-directionally magnetic stripes.

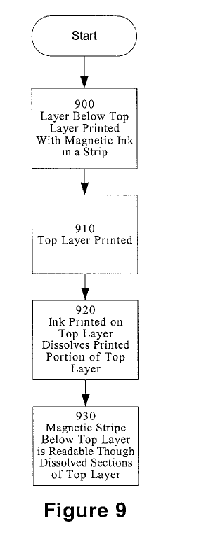

FIG. 9 illustrates the process of printing a magnetic stripe in accordance with one embodiment of the present invention. At block 900, a layer below the top layer is printed with magnetic ink in a strip. At block 910, the top layer, that sufficiently interferes with the magnetic field of the magnetic ink stripe, is printed. At block 920, the ink printed on the top layer dissolves the printed portion of the top layer. At block 930, the magnetic stripe below the top layer is readable though the dissolved sections of the top layer.

Layered Paper with Re-Useable Regions

In one embodiment, layered paper is removably placed in a notebook (e.g., a notebook organized for personal planning purposes). A sheet of layered paper in the notebook is formed in regions. In one embodiment, the regions are narrow bands of alternating color or hue. In another embodiment, each band is peelable by means of a small tab. In various embodiments, the bands correspond to times of day, phone numbers to be called or items on a to-do list. As each item is accomplished, the band on which the item is printed is removed. Thus, an empty band is exposed for new tasks. In one embodiment, the final layer is alternately colored to indicate the end of peelable layers. In this way, a single sheet of layered paper records notes or tasks and accommodates revision and change without recopying of the other items.

Adhesion

In one embodiment, no adhesives are used to bond layers of layered paper together. In another embodiment, adhesives of limited use are used to enhance the characteristics of layered paper that uses no adhesives. In one embodiment, adhesives similar to adhesives used on notepad paper to make the notes removable, replaceable and postable are used together with an adhesive having a self-aggregating tendency when released from the zone between two sheets in order to make re-application of the adhesive impossible. In one embodiment, authenticating symbols (e.g., identifiable signatures, seals, watermarks and codes, or other selected information) are embedded into the adhesive beneath a clear, tinted, frosted, or translucent layer. Thus, authenticating symbol is visible through the top layer. The adhesive is chosen such that the integrity of the adhesive or of the superimposed or interjected imagery is destroyed upon peeling or lifting apart the layers held by the adhesive.

In one embodiment, one or more layers of the layered paper have compressible surfaces with a very high coefficient of static friction when under compression. In one embodiment, the compressible surfaces are made to join semi-permanently or permanently by various chemical or adhesive coatings.

Adhesion by Interlocking Structures

In one embodiment, interlocking structures on facing surfaces are used in a sheet of layered paper. In another embodiment, a randomly-textured binding surface is structured so that, upon application of surface pressure, the textural elements of the surface tend to lock together. In one embodiment, surfaces of layers are made compressibly binding by canting the walls of a randomly-spaced “grain” element in such a way that the grain presents an undercut profile (mushroom-like or keystone-like) where the width of the average top, or presenting, surface of the grain-element is slightly larger than the average distance between grain elements. In one embodiment, grain elements are positioned in a pattern (e.g., equi-spaced hexagons) rather than randomly. Other embodiments use grain elements with other interlocking geometries.

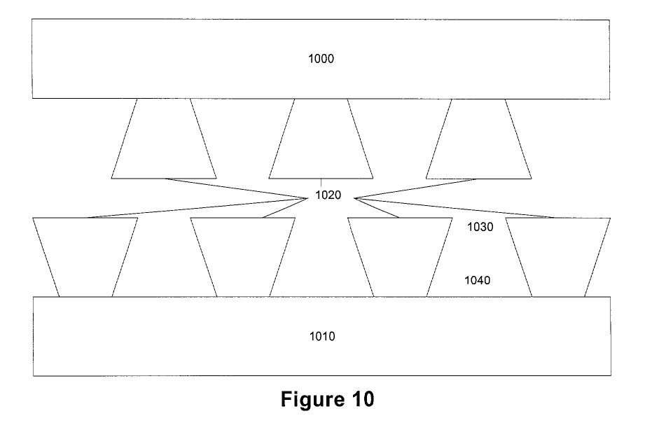

FIG. 10 illustrates the non-adhered surfaces of two layers that adhere using interlocking structures in accordance with one embodiment. An upper layer 1000 and a lower layer 1010 have grain elements 1020. Near the opposing layer, the space 1030 between grain elements is narrower than the widest width of a grain element. Near the attached layer, the space 1040 between grain elements is at least as wide as the widest width of a grain element.

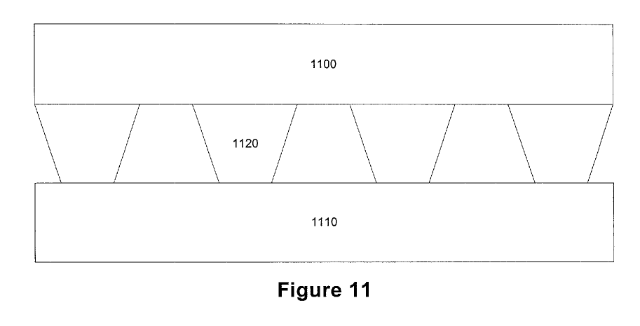

FIG. 11 illustrates the layers of FIG. 10 adhered together in accordance with one embodiment. An upper layer 1100 and a lower layer 1110 have grain elements 1120. The layers are compressed, forcing the wide parts of opposing grains past each other. The wide parts of opposing grains prevent the grains from separating without sufficient separating force being applied.

In one embodiment, a stochastic margin of error is allowed in the actual interlocking of grain elements across planar layers. In one embodiment, there is a direct spatial alignment of near microscopic pores and studs across part of two interlocking layers. In another embodiment, the mushroom-to-undercut-cup linkage realized in a nano-tech, or micro-scale, way causes a layer to appear to be a gently granular surface imparting a milky quality to a clear plastic sheet. The grain elements are made of materials that are sufficiently elastic to interlock tightly by mutual compression. Thus, the top of a grain on a first layer fills the space between the bottoms of two grains on a second layer. If the two layers are made of materials with identical refraction indices, the two layers become clear when the first layer is bonded to the second layer.

In one embodiment, exposed surfaces of layered paper in which surfaces have interlocking elements need not be protected from contact with hands, printer mechanisms and the like because the surfaces are not adhesive coated. In one embodiment, geometries are used to cause the interlocking seal of the opposing layers to be sufficiently durable as to be permanent. In another embodiment, geometries are used to cause the interlocking seal of the opposing layers to be sufficiently durable as to be releasable only by making the “stem” portion of a mushroom-like stud sufficiently thin to break off when the sheets were caused to be peeled apart.

In one embodiment, breaking the stem portion of a grain element to separate two layers renders the separation irreversible. Such irreversibility is of great importance in such applications as gaming. In one embodiment, once separated, two layers (e.g., an obscuring layer on a game card) cannot be reattached.

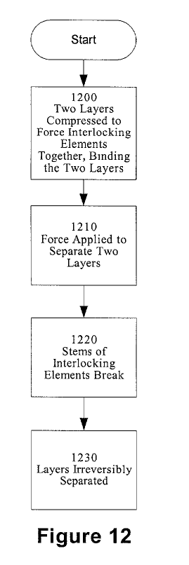

FIG. 12 illustrates the process of binding and irreversibly peeling two layers in accordance with one embodiment. At block 1200, two layers are compressed to force interlocking elements together, binding the two layers. At block 1210, force is applied to separate the two layers. At block 1220, the stems of interlocking elements break. In one embodiment, the elements are created such that the stems of the elements of one layer break, but the stems of the elements of the other layer do not break. At block 1230, the layers are irreversibly separated.

In one embodiment, solvents or adhesives are applied within the binding region of the stud-and-cup devices. In one embodiment, a microscopic, “hairy” surface (i.e., a surface with thin filaments projecting therefrom) of one layer is bonded by solvents or adhesives to another layer such that the microscopic hairs tear away upon separation of the layers. In other embodiments, the projecting structures have alternative geometries.

Micro-Encapsulated

In one embodiment, substances that alter the appearance of surfaces (e.g., from clear to a visible color, texture, or density) are micro-encapsulated in the stems such that the encapsulation ruptures when layers are separated. In another embodiment, substances that alter the appearance of surfaces are micro-encapsulated adjacent to the bonding-regions of an interlocking stack of layers such that the encapsulation ruptures when layers are separated. In various embodiments, the encapsulated substances are dyes, inks, heat or solvents.

Appearance Altering Binding Elements

In another embodiment, grain elements are made from materials that shift appearances when stretched or sheared. In one embodiment, grain elements contain a clear plastic “stem” or “hair” that stretches and disrupts the clarity of the stem, rendering it milky, as it stretched and then broken. The resultant surface of a layer after separation is subtly flocked and whiteish.

In one embodiment, two layers have bands defined on their surfaces, using varying geometries of grain elements. Thus, interlocking is only possible with sufficiently accurate registration. In one embodiment, size of a manually-oriented operation is ¼ inch. Varying binding schemes are employed across a ¼ inch band or region of the two binding surfaces. In another embodiment, two interlocking layers are to be interlocked by their edges by means of an overlap of ½ inch. There are two ¼ inch bands of dissimilar grain elements. Thus, the grain elements interlock only after they are accurately aligned. In one embodiment, a linear array, such as a linear projecting bead or wall received between two mating projecting walls, is used to ensure two layers bind only in a particular configuration.

Disappearing Marks/Printing

In one embodiment, parallel bands of adhesives are separated by a manually-scaled distance. Guide marks (e.g., registration marks or a registration line) guide a user to the appropriate place in which to press layers together. In one embodiment, such bands are marked with registration lines that are obliterated by erasing, dissolving, bleaching or other substances upon the appropriate positioning and locking of the layers.

In one embodiment, one layer contains lines printed with an ink or dye that is rendered invisible by the application of a second substance. The second substance is micro-encapsulated in capsules laid down on the surface of a second layer in the appropriate registering position. In another embodiment, the second layer also has a registration line or marker printed using the “disappearing” ink, chemical or dye. The act of accurately positioning and pressurizing the two layers or surfaces ruptures the solvent/ink-dissolving or dematerializing agent. The successful alignment of the two surfaces is assured and the alignment marks are rendered invisible.

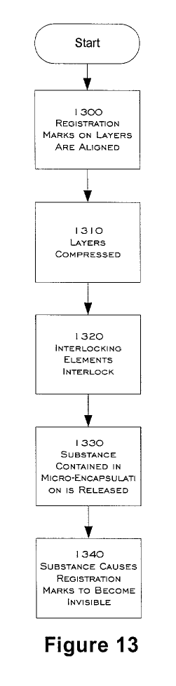

FIG. 13 illustrates the process of binding layers in accordance with one embodiment. At block 1300, registration marks on the layers are aligned. At block 1310, layers are compressed. At block 1320, interlocking elements interlock. At block 1330, a substance contained in micro-encapsulation is released. At block 1340, the substance causes the registration marks to become invisible.

In another embodiment, the surface of a layer or of its coating contain visible registration marks or other such indicators caused by the grain elements. A second layer contains a similar registration mark. In one embodiment, when the registration marks are aligned and interlocked, the surface is rendered smooth by the optical joining of complementarily grain elements. In another embodiment, when the registration marks are aligned and interlocked, the surface is rendered invisible by the wetting action of a micro-encapsulated substance (e.g., a solvent) that clarifies the layers. In one embodiment, the encapsulated substance fills small voids or perforations that form the registration markers.

Layered Paper for Composite Images

In one embodiment, layered paper is used for printing large graphics (e.g., posters). Layered paper is created in a standard size and shape agreeable to a printer. In one embodiment, 8.5 by 11 inch sheets of layered paper are created. In various embodiments, the sheets are made to affix to one another by any of several means, including those described above for binding layers of layered paper together.

In one embodiment, software spreads a computer/copier-contained image across multiple sheets of layered paper. In one embodiment, a standardized image size and family of orientations (e.g., 4 by 4 sheets, 3 by 6, and 2 by 2) is integrated into the software.

In one embodiment, an image (pre-divided and prepped) is provided to users/consumers (e.g., by the Internet or as an add-on to such media as CD's and DVD's). In another embodiment, software is distributed that enables a user to reliably condition an image provided by the user or third-party for printing over an array of layered papers. In one embodiment, the software, in addition to computing the boundaries and borders of an image, is equipped with the ability to calculate seamless “feathered” borders to conceal the juncture of the dispersed imagery.

In one embodiment, sheets of layered paper are optimized for joining together into a contiguous whole. In various embodiments, the layered sheets are coated, molded or otherwise optimized around their borders for mutual adherence as described above. In one embodiment, a region of mutual overlap between adjacent sheets is established. In one embodiment, the layered paper is opaque like conventional pulp paper, and the region of mutual overlap is a border (e.g., a border ½ inch in width). In one embodiment, the border is of uniform width. In another embodiment, the width of the border is varied to produce a pattern (e.g., interlocking teeth).

In one embodiment, sheets of layered paper are formed in two thickness layers such that the thickness of the border is half of the total thickness of the rest of the sheet. In one embodiment, the half-thickness border areas are covered with a removable shielding frame. In one embodiment the thickness of the shielding frame is also half of the total thickness of the rest of the sheet. Thus, the border and shielding frame combined are the same thickness as the rest of the sheet.

In one embodiment, large images are printed across a plurality of sheets of layered paper. Two adjacent layered sheets are printed such that the recessed borders of one sheet faces the printing mechanism of a printer and the recessed borders of the adjacent sheet faces away from the printing mechanism. Upon removing the shielding frame, the borders of two adjacent sheets are joined by any of the above methods (e.g., adhesive, interlocking geometries) to form a composite image across the boundary of the two sheets. Since the thickness of the borders of each sheet is half the total thickness of a sheet, the thickness of the joined borders is the thickness of the total sheet. Thus, the thickness of the composite image is uniform.

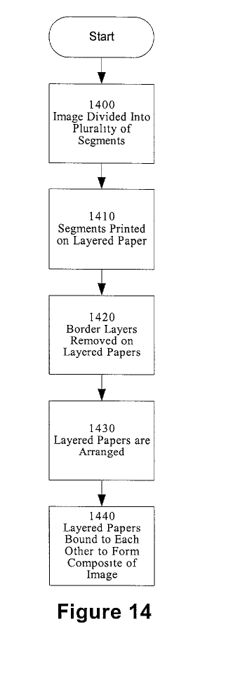

FIG. 14 illustrates the process of printing a composite image on layered paper in accordance with one embodiment. At block 1400, an image is divided into a plurality of segments. At block 1410, the segments are printed on layered paper. At block 1420, border layers are removed on the layered papers. At block 1430, the layered papers are arranged. At block 1440, the layered papers are bound to each other to form a composite of the image.

In another embodiment, one sheet of layered paper displays the image-section entirely on an opaque surface. Another portion of the image resides on an opaque surface with a clear, image-bearing overlay in the border section of a second sheet. In one embodiment, the layered paper is a printable plastic sheet overlaid on a paper backing in such a way as to effect removal of the border to expose only the clear region. In one embodiment, the areas of interlock are reduced to half of the area of overlap. For example, in a 1 inch border ½ inch is structured as the interlocking area of reduced thickness described above. The other ½ inch is feathered slightly so that the central printed area of the fully opaque sheet is slightly overlapped by a clear border on a printed area of another sheet.

In one embodiment, removable borders are formed on standard-size sheets. Printing is extended to the border, allowing bleeds or near-bleeds to be printed. In one embodiment, an assembled composite image has a clear overlay that covers 1 inch of printed area on the opaque sheeting. In one embodiment, software re-sizes and distributes the image across an array of sheeting and feathers the printing of the clear overlays in such a way as to cause a mathematically-perfect summation of the image-borders upon overlap. In other embodiments, clear or translucent registration sheets and positioning aids are used.

In one embodiment, layered sheets used in printing composite images have removable/peelable layers that are used by a user to arrive at accurate registration of the individual elements of the composite image. In another embodiment, a single clear layer of plastic of sufficient thickness to retain dimensional stability is imprinted with a section of image. In one embodiment, the layer is imprinted while attached to a substrate layer. After printing, the imprinted layer is peeled away from the substrate layer. In another embodiment, the layer is imprinted while not attached to another layer. The imprinted layer is applied to a substrate layer having accurate registration marks. In one embodiment, the accurate registration marks are in removable border-zones of other layered sheets. In one embodiment, the registration marks are made disappearing by any of the methods described above.

In one embodiment, the substrate sheets are interlocking sheets of layered paper. In one embodiment, the substrate sheets are interlocked before the imprinted layer is attached. In another embodiment, imprinted layers are attached to substrate sheets before the substrate sheets are interlocked.

In one embodiment, layered paper for creating composite images is provided to a consumer by means of conventional retail channels. In another embodiment, layered paper is provided to a consumer by means of advertising programs (e.g., placing layered sheets into publications, mailings and the like).

Backing Panels for Composite Images

In one embodiment, the printable clear layers are mutually adherent. In one embodiment, the clear layers are optionally applied to a transparent, translucent or opaque backing panel. In one embodiment, the backing panel is composed of layered sheets. In another embodiment, the backing panel is assembled by another means. In one embodiment, translucent backings are rear illuminated. In another embodiment, a printable layer with a removable/permanent backing is attached to a window glass.

Adherent Tape Binding

In one embodiment, layered paper pre-bordered with an adaptive contour is made with no inherent provision for mutual adherence. An adhering substance is attached (e.g., rolled-on, taped, or otherwise applied) to the bordering regions. In one embodiment, a matching set of binding topographies is supplied because of the extremely small thicknesses required for a micro- or nano-manufacture of the binding topographies. In one embodiment, the binding topographies are ball and orifice types, and are supplied in rolls of male and female tape (i.e., elongated, relatively narrow sheets) able to be dispensed from a traditional tape dispenser. In one embodiment, the tape dispenser holds both types of tape.

In one embodiment, the “tape” is manufactured in a “hermaphroditic” design that intermixes both male and female elements in such a way that an effective number of male/female couplings are achieved to effect a suitable adhering of two surfaces. In various embodiments, hermaphroditic binders are made in a variety of scales, depths and bonding strengths. In one embodiment, hermaphroditic binders are evenly spaced mushroom-like “knobs” on stems. In one embodiment, the distance between knobs is greater than the stem diameter, and less than the knob diameter. In another embodiment, the height from the mounting surface to the underside of the knob is slightly greater than the depth of the knob.

In one embodiment, the tape is adhered using an adhesive that is stronger over a short (pull-apart) time than the strength of the hermaphroditic binding force. In another embodiment, a quick-drying viscous material (e.g., a solvent-immersed plastic) is made to form into a binding geometry (e.g., curling hairs or knob-like protrusions) by being pulled away from a suitable barrier at the approximate moment of dispensing of the tape. Upon swiftly hardening, these binding geometries are inclined to entangle upon mutual contact. Thus, a removable/releasable tape or surface or strip is formed.

Separate Printing and Assembly

In one embodiment, layered paper is used to allow the creation of value-added spaces and/or perceived value-added spaces in the traditional print-publication world. In one embodiment, layers are printed in isolation. In one embodiment, stiffening substrates are used in printing. In another embodiment, stiffening implants are used in printing. In one embodiment, after layers are printed in isolation, the layers are formed together by means of a registering and pressure-applying device. In one embodiment, the registering and pressure-applying device is a multiple registered feed device that feeds the layers to pressurizing rollers wherein each of the multiple feeds corresponds to a layer of the layered sheet.

Layered Printing of Signifier Cards

In one embodiment, an underlying image is printed one a layer. An obscuring layer (e.g., opaque, clear or translucent layer, itself printed with blocking, opaque inks or translucent inks/dyes/colors and substances such as scratch-off layers or regions) obscures part of the underlying image. Thus, a user may reveal layers or regions with successive removals of top layers using layered paper. In another embodiment, layered paper is used to emulate the functions of the “windowed” signifier/gaming card described in U.S. Provisional Patent Application No. 60/215,444, filed Jun. 30, 2000, and incorporated by reference herein.

In another embodiment, layered paper printed with two layers is used to cause a second image to appear beneath a first in a sequentially-related way. In one embodiment, an advertisement appears on a second layer. Thus, advertisements are allowed to appear in previously off-limits areas. In another embodiment, an element that is less than desirable in the long-term (e.g., an advertisement) is only on the topmost peelable layer. In one embodiment, a second layer is partially visible through the top layer. The partially visible material is sufficient to pique the interest of the viewer to remove the top layer.

In another embodiment, the second layer also contains information (e.g., advertising) that a sponsor wishes the viewer to see. In one embodiment, a magazine cover printed with layered paper depicts a starlet. The depiction is printed on the top layer of the layered paper. On the next layer, the same starlet appears scantily clad and wearing the advertiser's jogging shoes. In one embodiment, part of the image of the scantily clad starlet shows through the top layer. The top layer is imbued with some obscuring material so that part (e.g., a region containing areas of interest to the reader) of the unclad figure on the lower layer is obscured.

In one embodiment, layered paper is used in incentive applications (e.g., gaming or coupons). In one embodiment, some of the contents of lower layers are key to the titillating aspect of an incentive device (e.g., a gaming card or a coupon) device. In one embodiment, symbols (e.g., signifiers, numbers, images and shapes) are distributed across the layers for the purpose of enticing a consumer with the promise of real or imagined rewards.

Back Printing and Porous Layers

In one embodiment, a sheet of layered paper is printed on the back surface. In one embodiment, the back surface is a porous film of plastic. The interior of the back film is a fibrous paper or paper-like synthetic. The fibrous members of the interior fiber are made available (e.g., by being caused to extend) to the pigments (e.g., inks, dyes and the like) applied to the porous, non-absorbent backing film. In one embodiment, the pigments are pulled into the interior fibrous layer by capillary attraction. Once in the interior fibrous layer, the pigments affix themselves and form an interior image below the front sheet of the printable plastic film.

In one embodiment, the rear-introduced images would be obscured from a front view, by means of opaque adhesives. In other embodiments, similar means, are used to obscure the rear-introduced images from a front view. In another embodiment, the image is similarly obscured from a rear view by use of an opaque backing sheet. In one embodiment, the sheet of layered paper with the rear-introduced image is inserted into a conventional printing device for printing of a front image after the rear-introduced image is printed. In another embodiment, the rear-introduced image is printed after the front image.

In one embodiment, additional layers (e.g., front and back layers) accommodate registration techniques. In another embodiment, additional layers accommodate preprinted elements. In one embodiment, layered paper is used for the internal elements of a to-be-assembled element (e.g., a ticket or a coupon). In one embodiment, the internal elements are formed (i.e., preprinted) with visible elements (e.g., promotional codes and symbols). In another embodiment, the internal elements are formed with machine-readable elements.

In one embodiment, layered paper is used to assemble an item of real or perceived value (e.g., a coupon, a ticket, a check or a game piece). The item is broken into two or more parts. In one embodiment, four parts are spread throughout a publication. In other embodiments, the parts are spread throughout any of many content delivery options (e.g., several publications, across multiple issues of the same publication, etc).

In one embodiment, upon assembly of all the parts, a pattern (e.g., a signifier string) emerges. In another embodiment, the reward is inherent in the assembled device itself (e.g., a coupon). In one embodiment, the assembled device is a ticket to an event. In another embodiment, a user is required to interact in some way to validate the ticket to discourage theft of ticket elements from an unsold publication. In one embodiment, the ticket is assembled or placed upon a printable size sheet of paper in its final embodiment. Then, the ticket is placed in a printer and/or scanning device for a final addition of a validating code or image to be impressed upon it prior to the user spending its value. In one embodiment, identifying information (e.g., subscription codes) is encoded into one or more of the signifiers. In one embodiment, the assembly of the ticket involves authentication practices. In this embodiment, the ticket cannot be used anonymously.

Magnetic Stripes

In one embodiment, a magnetic stripe (e.g., a legacy credit-card stripe) is duplicated by the selective transfer of pre-magnetized material using one of the printing methods described above. In one embodiment, a thin magnetized layer of material is released by the direct action of an ink solvent of a conventional printer. In another embodiment, a thin magnetized layer of material is released by the direct action of sequestered solvents encapsulated in a sequestering device (e.g., a capsule). The sequestering device is soluble by the ink solvent or carrying medium.

In one embodiment, a second credit card stripe is provided (e.g., on the reverse side of a card made of layered paper) to accommodate additional recorded data. In one embodiment, layered paper is used to locally create cards having magnetic stripes (e.g., credit card stripes or bank-card stripes).

In one embodiment, dual polarity magnetic stripes are printed on layered paper. In one embodiment, a substrate (magnetic stripe) layer is printed and a registered magnetic-bearing layer of opposing polarity (direction) is placed over the created stripe. Then, the top layer is selectively transferred to the substrate layer (e.g., by ink solvents) to form a dual polarity magnetic stripe.

In another embodiment, a magnetic stripe of opposing or enforcing polarity is placed onto the backside of the layered paper in registration with a magnetic layer printed to the front side. In one embodiment, the thickness of the card material is minimized in the magnetic stripe region (e.g., one or more layers are removed to form a channel. The rear-applied field bearing material has a proportionally increased field strength, thickness and size to create a balanced bi-polar field in the front “reading” area.

In another embodiment, a template is provided in the general form of a credit/debit card with the appropriate standard spacings and width with relation to the stripe and the card's edge. In one embodiment, the card is imprinted with additional data and/or imagery. In one embodiment, the multiple layered paper construction encompasses only the region of the stripe's application, leaving other areas free to accept normal inks, or other forms of ink (e.g., decorative metallized layers). In another embodiment, layered paper encompasses more than the region of the stripe's application.

Credit and Calling Cards

In one embodiment, cards bearing user credits (e.g., a credit card) are created with a printed and fixed face-value. In one embodiment, a user converts his or her credits to a fixed-value spendable credit. In another embodiment, the card is used as a phone “calling card”. In one embodiment, credits are obtained by participating in a program that provides such credits. In another embodiment, credits obtained for various media consumption (e.g., through other programs) are converted into a credit freely dispensable and applicable to unrelated areas of purchase. In one embodiment, such credits are collected and dispersed entirely in cyberspace.

In one embodiment, a card reading device (monetary/credit/debit card reader or barcode reading device) is modified to function as a card writing device. In another embodiment, card reading/writing devices are manufactured that function both as card readers and as card writers. In one embodiment, writing is accomplished by any means (e.g., optical, magnetic, chemical, crystalline, mechanical and electronic means). ATM machines, credit card readers, barcode scanners and the like have not typically been points of writing for users. In one embodiment, credits are altered (e.g., added, removed or transferred) on cards containing layered paper using non-traditional writing means (e.g., ATM machines, credit card readers and barcode scanners).

In one embodiment, a user provides transaction information (e.g., information indicative of coupon earnings, returned change, or specific credit/cash sums) on cards printed on layered paper (e.g., face-value cards). In another embodiment, transaction information is sent cybernetically from a card reading device to the user's on-line repository. In one embodiment, the on-line repository is an account (e.g., merchant or personal) accessible on-line. In an example embodiment, money saved from an airline ticket refund or discount program is routed automatically and/or volitionally to pay for other items (e.g., groceries or clothing) directly. In one embodiment, items are charged at full-price and a portion of the sales costs is redistributed directly to another purpose. In another embodiment, the redistribution is made through an intermediary device of a promotional credit system.

Templates

In another embodiment, isolated strips of binding materials (e.g., the above described tape or binding layers) are placed across the surface of printable layered paper. The layered paper is later used (e.g., folded and/or attached to additional sheets or other devices) to form composite articles (e.g., booklets, DVD cases or other containers and other useful articles) from standard printable templates.

In various embodiments, such templates are provided by a number of means. In one embodiment, the standardized software and/or industry-standardized DVD, CD or Flash-card artwork used to print packaging and/or labeling for a purchased (or downloaded) media product is downloaded from a website. In another embodiment, the standardized software and/or artwork is e-mailed to a consumer. In one embodiment, the cost of a blank is borne by advertisers or sponsors. In one embodiment, blanks are provided preprinted with messages. Space for the preprinted messages is statically or dynamically allocated by the to-be-downloaded artwork. In another embodiment, the messages might arrive with the artwork.

In one embodiment, a code or message is entered into the user's receiver/computer. The code is provided by (i.e., printed on) the printing blanks. In one embodiment, rewards (e.g., lotteries) are offered at the point of download. In one embodiment, an offered reward profitably interacts with material appearing on the pre-printed blanks. In another embodiment, the offered reward interacts with material appearing on the artwork.

In one embodiment, different pieces or aspects of a composite product (e.g., quadrants of a poster) are obtained from multiple sources (e.g., different websites, virtual locations, purchases, or participations). In another embodiment, a consumer is given several levels of ad-sponsorship from which to choose. The price is set between a floor price and a fall-retail price dependent upon the level selected. An enabling device (e.g., a code) is granted after a level is chosen. In one embodiment, downloadable artwork as described above is provided in the basic download or purchase cost.

Revealable Markings

In one embodiment, markings (e.g., barcodes) are made discoverable through the use of layered paper. In another embodiment, markings are made removable through the use of layered paper. In yet another embodiment, a barcode is made relocatable through the use of layered paper. In one embodiment, markings are aggregated and/or interact to create a reward (e.g., credits or entries in lotteries). In another embodiment, the removal of a barcode element reveals incentivizing elements (e.g., gaming information) beneath the markings (e.g., codes, watermarks or price-stickers). In one embodiment, a revealed element contains a part of a marking (e.g., an image, series or code) that leads to a reward (e.g., entry into sweepstakes or multiplication of credit due to the consumption or purchase of synergistic products or services.

In one embodiment, layered paper is used to encapsulate or house openable or ruptureable elements. In one embodiment, layered paper is printed with normal page content. The layered paper also contains visual layers and peel-off zones that visually tie an entrapped substance (e.g., scents and scent-capsules) with surface-printed matter. Removing the peel-off zones releases the entrapped substance.

Encapsulated Samples

In another embodiment, layered paper contains (i.e., through micro-encapsulation or creation of regions in which bound or loose materials are sequestered) samples of products (e.g., powders, pastes, creams, spreads, and even liquids). In one embodiment, a sample is sequestered within a region of layered paper. In another embodiment, the sample is sequestered within entire layers of layered paper. In one embodiment, a make-up and cosmetic free “nite-out” kit is sequestered in layered paper.

In one embodiment, elements similar to bandages with pre-provided adhesive tape are formed into (or bound onto) a paper-like sheet. The sheets of bandages are bound into folios to be packed and transported. In another embodiment, bandages made using layered paper contain (in micro-encapsulation) reactive chemicals. In one embodiment, the reactive chemicals produce an endothermic reaction when released. In another embodiment, the reactive chemicals produce an exothermic reaction when released. In one embodiment, the act of peeling a bandage's adhesive-protection backing releases the reactive chemicals. In another embodiment, the reactive chemicals are released by removing the strips from a protective backing. In other embodiment, other physical manipulation (e.g., crushing, pressurizing, stretching or folding) is used to release the reactive chemicals.

Making Inherently Non-Absorbent Layers Absorbent

In one embodiment, the surface of a layer that is inherently non-absorbent to pigment (ink, toner, etc.) is made absorbent to pigment. In one embodiment, the surface is coated to make it absorbent. In another embodiment, the surface topography is altered to make the surface absorbent. In another embodiment, the surface is embedded with surface materials to make the surface absorbent. In an example embodiment, a coating of micro-capsules formed of a substance soluble by the base of the anticipated ink or pigment contains an accepting layer consisting of a porous cellulose fiber in a binder. In one embodiment, the binder does not penetrate the cellulose, and is activated only upon release and/or mixture with the applied ink or pigment base.

In another embodiment, a cellulose fiber (or its synthetic or bio-engineered/nano-engineered analog) is placed within (i.e., woven into, bonded into or placed in micro-pores within) the surface of the ink-accepting surface. In one embodiment, microscopic (e.g., etched, molded or heat-induced) pores form pockets containing microscopic ink-accepting items (e.g., fibers, chemical substances or powders) incorporated into the ink-accepting surface.

Layered Paper Bandages

In another embodiment, substances having therapeutic uses (e.g., antibiotics, analgesics, disinfectants, hydrogen peroxide, zinc oxide, aloe vera extracts/juices, Lidocaine, etc.) are sequestered in layered paper used to make bandages. In one embodiment, the substances are sequestered within the removable (e.g., peel-away, break-away or tear-away) covering for the dressing portion of the first-aid strip or bandage. In one embodiment, the substances are kept sealed from contact with the air and from mutual contact. Thus, the release of substances and combinations of substances that are inherently unstable once deployed is enabled.

Seamless Layered Wallpaper

In one embodiment, wall coverings (e.g., wall paper) are made from layered paper. The coverings are created in a seamless fashion using overlap and/or the technology of registration and interlocking as described above.

Packaging

In one embodiment, layered paper is used for exposed applications (e.g., covers of printed material, product packaging, on an outer surface of a product or on a section of any of the foregoing). In another embodiment, layered paper is used to provide simple peelable covers or packaging or regions thereof. In various embodiments, the peelable packaging is used on magazines, books, calendars, greeting cards, manuals, brochures and the like. In one embodiment, the layered paper is used for the purpose of enhancing in any real or perceived way, the value of the item.

In an example embodiment, the outer layer removes to reveal information (e.g., an advertisement and/or promotional/gaming/couponing/barcoding and similar items) on the covers of publications or other items. In various other embodiments, layered paper is applied to packaging, surface finishes of material goods, and any visible region of products. In one embodiment, the surface of a product (e.g., a CD, DVD, the packaging of software or the cover or similar surface (e.g., a software manual or training program)) bears signifier strings/images that, when appropriately removed by such methods as are described in my U.S. Provisional Patent Application No. 60/215,444, filed Jun. 30, 2000, incorporated herein by reference, generate a reward (e.g., a toll-free support number or URL) only when the appropriate removal (e.g., in insolated segments) is performed. In another embodiment, layer paper is provided on a product or packaging for a product (including software on media) that, when removed in a proper manner, results in furnishing of information that enhances the value of the product or provides items of value to an owner or user of a product.

Ink-Selecting Layers

In one embodiment, a porous overlay layer that allows one ink (e.g., black ink) to penetrate through, or deeply into its structure is provided. The porous overlay is, then, caused to react only with an ink of another color. The reaction causes the selective binding of the overlay layer to that ink. Thus, a removable obscuring layer is created above the underprint. In various other embodiments, additional treatments (e.g., flocking, scratch-off obscuring layers, embossing, etc.) are applied by printers that have no special inks or feeder mechanisms. In one embodiment, a coating is provided containing sequestering elements (e.g., dissolvable capsules, honeycombs, similar sequestering elements or, in the case of impact printers, shatterable capsules or similar elements) wherein the sequestered substance binds to the inked areas when released. In one embodiment, the binding layer is peeled off, or brushed away manually. In another embodiment, the printed area of the binding layer is caused to raise-up in the style of embossing.

In another embodiment, non-standard sized sheets (e.g., extremely large or small sheets) of layered paper is manufactured. In one embodiment, billboard size posters are created using layered paper.

Interlocking Multiple-Sheet Layered Paper Panels

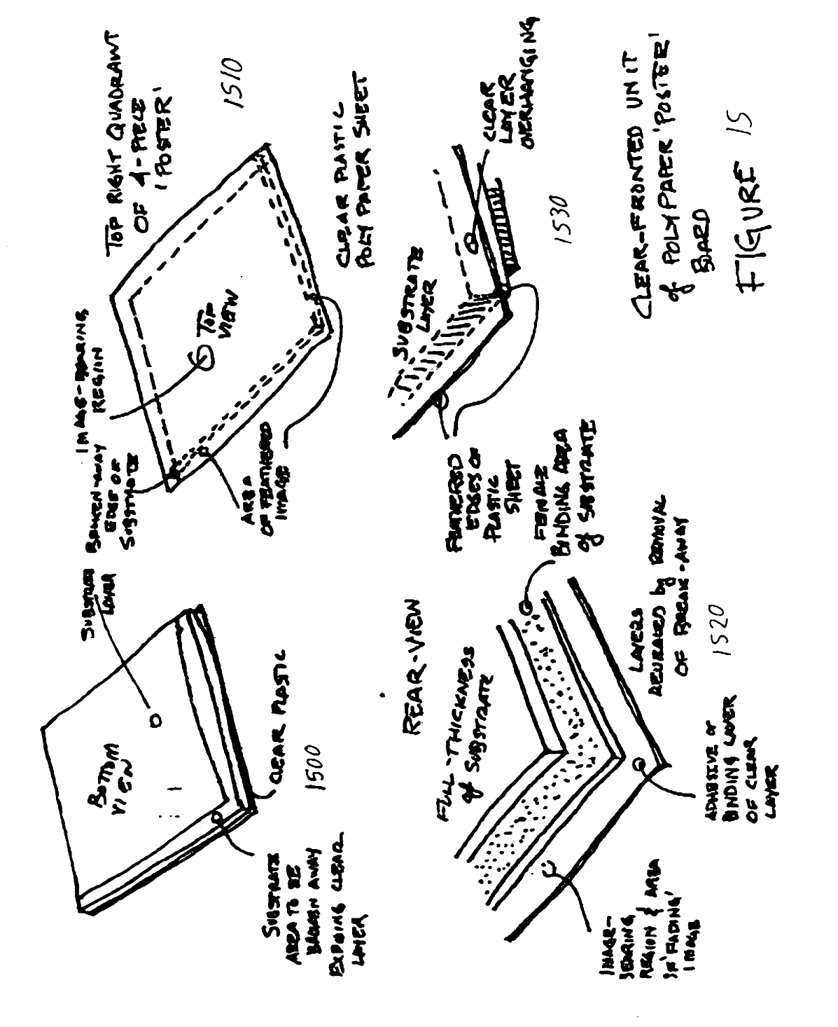

FIG. 15 illustrates a simplified depiction of the method by which the interlocking of multiple-sheet paper panels is achieved in the specific instance of a multi-part paper for the purpose of standardized assembly of a poster, or poster-like oversize sheet showing no visible seams in a printed image spanning those seams in accordance with one embodiment of the present invention. In other embodiments, the interlocking of the borders between the sheets are both keyed by tongue-in-groove and/or mortise/tenon joints and additionally each sheet of such assembly is of a different shape in the region of the overlap and interlock to create a precise rectangular shape upon assembly. Section 1500 shows the back side of a clear-fronted panel. The L-shaped piece is scored or otherwise prepared to break away, after the printing of the front film area, to expose the laddered binding region. Section 1510 shows a top view of a clear-fronted panel the dotted line bordering the two distant edges show the area to be printed.

In this embodiment, the border of the image to be imposed does not extend to the two nearer edges. These two edges are feathered or faded in a way to arithmetically and visually form a continuum with the front-printed opaque-surfaced sheet, which is also printed with a fading image in the area to be placed beneath the clear overlay of the adjoining panel. Section 1520 shows a detail of a rear view of the clear-fronted panel showing the laddered configuration of the edge-area exposed by the breaking-away of the border section. While the ladder appears to be robust dimensionally, it should be restated that these materials are conceived as nano- or micro-manufactured materials and so the actual thickness of the entire assembly is about the thickness of paper or cardboard. Both the rear of the clear overlay area and of the recessed area are prepared with binding topographies or adhesives.

Section 1530 shows a detailed front view of the clear-fronted panel. The plastic, or clear material, of the overlapping section is described as feathered. In a small refinement, such a sheet has its thickness tapered down at the edges and the front edge of the complementary mating opaque sheet is intended to have a similar and complementary loss of depth in the extremities of its mating surfaces that will be below the clear layer of an adjoining sheet. While, in one embodiment, the thickness of all of the sheets must be maintained uniformly to accommodate the demands of an unmodified printer's inking and feeding mechanisms, these tapers are imperceptibly small and so will not result in appreciable disruption of, for example, ink dispersion on the panel's surface.

Strategy for Substance Release Upon Printing or Other Application

A sequestering element such as a thin-walled bead is made of a substance that will dissolve upon the application of another substance such as the base-liquid of an ink. The ‘bead’ is embedded in a sheet-film in such a way that it is exposed to the layer below the surface of the sheet and is surrounded by wick-like material that causes any substance such as solvent to migrate into the surface of the sheet where the wick come into contact with the bead. Upon dissolving of an area of the bead—which can be assisted by positive pressure from within the bead—the bead releases its contents only into the lower layer. Additionally, the wick could contain substances that would seal, swell, or harden after the application of the solvent. This would allow materials to be mixed within the layers of the sheet-film in such a way that they do not contact users. For example, an activator can be used for such purposes as generating light by phosphorescence, could be kept in the beads while the second substance could be sequestered (in pockets or bound in dry-form) between the layers of the sheet film.

Wicks and Closure of Pores Amplified

Pores that harbor wicks, or other capillary-action inducing structures, can also be caused to swell shut or otherwise seal by means of glues or sealants which become activated or which swell by the substance applied to the wick in to the area around it. For example, the area around each wick's pore could harbor a substance, for instance in the shape of a doughnut, that swells upon application of the substance applied to the surface of the sheet film (such as water which acts as a carrier or dispersing elements for ink). For example, a psyllium fiber mixed with a water-based glue, swells swiftly upon the application of a water-based ink. The doughnut-area surrounding a pore could additionally be used to transport the solvent, such as water in this example, to the wick or other element leading to the sequestering bead.

Use Of Dissimilar Ink Bases

By printing sheets with inks of dissimilar bases, the inherent qualities of the sheets is enhanced. For example, a sheet made to pass water-based inks through to an interior surface for the purpose of printing an interior layer or for the purpose of releasing a sequestered substance, or of triggering a mechanical or chemical reaction in the region between the sheets, could have an outer layer (the layer bearing the pores) that is antagonistic to oil-based inks in such a way as to encourage the bonding of those ink-bases to the outer surface of the sheet and refusing to pass the inks through to the wicks or other structures within or below the pores. The methods are well known and include regulation of the size and contour of the pores, as well as the substance-philic or substance-phobic character of the surface film, or the regions of it adjacent to the pores.

Note On ‘Carbon Fibers’

While they may be exemplary of stabilizing elements, any kind of dimensionally-stabilizing materials might be added to the sheet films, or caused to form the films themselves.

Embossing Inks

In one embodiment, embossing effects are created by the use of solvent-binding or sequestering substances or structures which are typically bound to the lower side of the region accepting inks in such a way that, upon application of an ink, the embossing substances adhere to the top surface of the hidden layer. They might also expand volumetrically after/upon adhesion. This also means that outer layers of these sheet-films might be made to be peeled off and discarded after printing.

Mag-Stripes

In one embodiment, thin films coated with, or embedding, or formed of, magnetized substances are caused to be transferred/adhered to an inner layer of sheet-film by the application of, for instance, ink. This means that the outer surface of the sheet film is also a porous film—perhaps embodying wicks like those above—that pass the solvent through to an inner layer of magnetized material which adheres to the obverse side of the porous outer film. Upon contact with the solvent the material dissolves sufficiently to be passed to the top surface of the next (inner) layer of film and bind there. The magnetic polarization of the regions thus transferred would remain intact due to a combination of the integrity of the transferring film (which indicates that it is able to pass through the solvent without falling apart—and this may indicate the use of internal structures such as weaves) and the natural tendency of the local particles or regions of the film to stay mutually attracted to one another, thus maintaining the polar alignment of the regions.

Additionally, bi-directional polarities can be created by the alternation of opposing field-bearing stripes in a known pattern easily matched by the overprinting of the enabling solvents or inks. That is N-S strips alternate with S-N strips to form a series of closely-spaced ‘stripes’ of alternately polarized material. In this way the reading of the stripes can be accomplished easily with a relatively broad read-head.

Poly-ply films also allow the ‘hiding’ of the conventional magstripe, such as that on a legacy credit-card, beneath a printable film or a thin film into which an image has been embedded or transferred by, for example, sublistatic printing methods.

General Note On Inks

In professional applications like large-scale printing of periodicals, it is cost-effective to load a press or other coating device with coating materials like slurries which are specifically unable to pass through the layers of the envisioned sheet-film, or with solvents specifically designed to affect only an inner or lower layer of the films.

Binding Topographies

In one embodiment, hermaphroditic materials are used on controlled rigidity elements, however, the invention is not limited to the binding-regions of papers, films, and tapes. Hook-and-loop strategies are used in another embodiment.

In one embodiment, tiny fibers, or setae, are used by means of the pulling away of a protective surface from a lower one. Two things are important to mention in this regard: 1/the ‘protective layer’ in one embodiment is nothing more than the next layer of ‘tape’ in a roll-type dispenser (that is, the use of a separate peel-off layer might not always be required) and 2/setae or microscopic fibers can also be formed of polymers that have inherent electrostatic potentials across their length, thus the tips of the fibers are negatively charged, while the ends attached to the sheet-film are positively charged. These polarities may be regionally-varied to cause ease of intertwining of the fibers or repulsion of the fibers resulting in non-bonding. Such polarities might be magnetic as well. In sufficiently small fibers other attractions such as VanderWaal's forces apply.

Tints Within Bonding Topographies

Inks, dyes, or other tinted substances can be encapsulated within the ‘studs’ of the hermaphroditic (or other bonding topography) devices. Various patterns of colors could be thus sequestered causing a recognizable pattern such as a photographic image, logo, or text, to become visible upon the tearing-away of a bound region. Further, in one embodiment capillary attraction, wicking and other methods are used to allow the (conventional) printing of images onto the rear surface of a film containing such a bonding topography in such a way that the ‘inks’ are drawn into the shafts far enough to be exposed upon tearing-away of their tops. The rear surface then is sealed from inspection by the application of a second continuous layer of coating material such as latex.

Mating Sheets Amplified

The next application deals specifically with ways of increasing the thickness of paper-like sheets. When alignment strategies like the ‘sawtooth’ are discussed, it is assumed that the backing layer is a little thicker than ordinary paper. Clearly, a thicker substrate bears the scoring and sawtooth alignment structures better than thin stock.

Backing layers formed of cardboard or sheet-film in one embodiment are tapered on their edges to allow easy feeding into a conventional printer. That is, a backing board as thick as a heavy cardboard can be made suitably flexible to pass easily through a printer, but because of its edge-thickness it would not pass through the paper-separating mechanism/blade. By tapering it down to the thickness of a traditional text-weight stock at the edge(s) it tricks the feed-mechanism into accepting it. The thicker material then makes the job of alignment of sheets very simple.

In a refinement, open-cell foam is used to form in such a substrate sheeting. The regions of open-cells may be limited to small areas of a sheet. That is, the cells open to one another in a small area of sheeting that is sealed from the next, or in such a way that the cells are open only in the front-to-back dimension, not side-to-side. In this way a seal applied to the front and back of such a foam when compressed prevents its expansion with gas/air unless one of the front back seals were removed. This has the advantage of limiting the effects of air-leaks to local areas of the sheeting. The air is allowed to enter by the simple means of removal of a air-tight peel-off backing.

If the edges of the foam are sealed it may be compressed during manufacture to drive the air/gases out of its cells and then globally-sealed by means of an air-tight peel-off backing. This creates a thin-profile backing for ease of printing. After the printing, the backing is peeled away allowing air/gas to enter the pores and expanding it. If the pores were coated with, or other wise sequestered or embodied a material that would harden upon exposure to air, atmospheric moisture, or gas then the sheet is made to stiffen or rigidify swiftly after the removal of such a peel-off layer.

In one embodiment, the foam above is impregnated or otherwise coated with, for example, a polymer capable of room temperature vulcanization. Silicone, for example, can be cured simply by the addition of atmospheric moisture. These RTV silicones will cure faster with the addition of more moisture. In a refinement of the above, the pull-off seal rests against a porous or perforated layer. The pores are small so as to atomize the air upon entrance to the interior of the film ‘sandwich’. Additionally, these pores may be sealed with a sheet coating or a sealing film that ruptures upon the application of atmospheric pressure or the suction induced by the foam's expansion when the peel-away element is removed. This thin layer or film may be wetted with water or water-containing material. The pores may be slightly deformed in manufacture as well causing them to be slightly concave. In these concavities, the water or water-containing material are housed. This material is then protected from evaporation by the application of the peel-off layer. Upon removal of that layer by the user, the film is ruptured and the moisture of moisture/catalyst-containing material is forcefully atomized or injected into the RTV silicone, thus speeding its cure-time.

Film Transfer and Remote Sensing

Conductive inks, slurries, and thin films are used in one embodiment of the present invention. Specifically, aluminized films and aluminum slurries make excellent reflective surfaces for RF. Other conductive materials may be used to print O's of various sizes that can function, for example, as toroids. O's of varying size are printed and then caused to resonate with a particular signature in the presence of an electromagnetic field. These methods are of particular importance in the printing of remotely recognized patterns.

Image-Summation

The feathering of images across borders meant to join is meant to create a summation across the area of feathering that is visually invisible. This means that depending on the translucency or opacity of the ink various strategies are employed. For example with translucent inks the underlying image border printed on the opaque stock is tapered away as the overlay image was tapered to form a linearly-static sum. With opaque inks, a spatial analog is usefully employed. Here the underprinted image replicates the overprinted (on clear stock) image. But the overprinted image might become progressively less dense through the use of regions like conventional half-tone dots or random grain or stochastically-weighted patterns as the edge of the clear overlay sheet was reached. It is suggested that an intentionally ‘blotchy’ or striated weighting to the patterns of the overlay ink be used to confuse the eye of the viewer and thus render the exact area of the joining of the images difficult to perceive.

Tickets and Other Items of Value

In another embodiment of the present invention, joining ‘papers’ to form smaller items that simply require the assembly of multiple parts, perhaps from disparate locations, is implemented. This is done with or without the use of multiple layers of printing. But collectively the use of the layers and/or locking pieces form a business system of significant power. Employed with the signifier system of the present invention, numerous variations are possible.

In one use, parts of an event ticket or gaming ticket are spread through the parts of a publication or through multiple publications. They are assembled to form a functional ticket. The ticket can also be imprinted or made to otherwise embody codes, signifiers, or messages. Some of these might be caused to be removed only at a later time or place. For example, upon assembling a ticket, a user would have to visit a qualified location or site to determine, by removal or other manipulation of layers, the level of ‘winning’.

Addition to Adhesion Methods

In one embodiment, activators allowing the release or causing the bonding of substances or elements (such as magnetic films) are among the substance that are sequestered in capsules or regions. For example a 2-part epoxy can be activated through the release of a hardener in the ruptured capsules.

Thus, a method and apparatus for layered printing is described in conjunction with one or more specific embodiments. The invention is defined by the following claims and their full scope and equivalents.

1. A method of layered printing comprising:
providing a first layer of paper-like material;
printing upon said first layer;
providing a second layer of paper-like material; and
adhering said first layer to said second layer.

2. The method of claim 1 wherein said step of adhering comprises:
applying an adhesive between said first layer and said second layer.

3. The method of claim 2 wherein said adhesive enables detachment and reattachment of said first layer and second layer.

4. The method of claim 1 wherein said step of adhering comprises:
providing a first set of interconnecting elements on said first layer;
providing a second set of interconnecting elements on said second layer;
compressing said first set together with said second set; and
interlocking said first set and second set.

5. The method of claim 1 wherein said step of printing comprises:
printing with a special ink.

6. The method of claim 5 wherein said special ink contains a solvent.

7. The method of claim 5 wherein said special ink contains magnetic material.

8. A layered paper printing system comprising:
a first layer of paper-like material;
a printer configured to print upon said first layer;
a second layer of paper-like material; and
an adhering means configured to adhere said first layer to said second layer.

9. The layered paper printing system of claim 8 wherein said adhering means comprise:
an applicator configured to apply an adhesive between said first layer and said second layer.

10. The layered paper printing system of claim 9 wherein said adhesive enables detachment and reattachment of said first layer and second layer.

11. The layered paper printing system of claim 8 wherein said adhering means comprise:
a first set of interconnecting elements on said first layer;
a second set of interconnecting elements on said second layer;
a compression device configured to compress said first set together with said second set; and
an interlocking system configured to interlock said first set and second set.

12. The layered paper printing system of claim 8 wherein said printer comprises:
a printing mechanism configured to print with a special ink.

13. The layered paper printing system of claim 12 wherein said special ink contains a solvent.

14. The layered paper printing system of claim 12 wherein said special ink contains magnetic material.

15. A computer program product comprising:
a computer usable medium having computer readable program code embodied therein configured to perform layered printing, said computer program product comprising:
computer readable code configured to cause a computer to obtain a first layer of paper-like material;
computer readable code configured to cause a computer to print upon said first layer;
computer readable code configured to cause a computer to obtain a second layer of paper-like material; and
computer readable code configured to cause a computer to adhere said first layer to said second layer.

16. The computer program product of claim 15 wherein said computer readable code configured to cause a computer to adhere comprises:
computer readable code configured to cause a computer to apply an adhesive between said first layer and said second layer.

17. The computer program product of claim 16 wherein said adhesive enables detachment and reattachment of said first layer and second layer.

18. The computer program product of claim 15 wherein said computer readable code configured to cause a computer to adhere comprises:
computer readable code configured to cause a computer to obtain a first set of interconnecting elements on said first layer;
computer readable code configured to cause a computer to obtain a second set of interconnecting elements on said second layer;
computer readable code configured to cause a computer to compress said first set together with said second set; and
computer readable code configured to cause a computer to interlock said first set and second set.

19. The computer program product of claim 15 wherein said computer readable code configured to cause a computer to print comprises:
computer readable code configured to cause a computer to print with a special ink.

20. The computer program product of claim 19 wherein said special ink contains a solvent.

21. The computer program product of claim 19 wherein said special ink contains magnetic material.
